(19) United States
(12) Patent Application Publication
(10) Pub. No.: US 2002/0186741 A1
(43) Pub. Date: Dec. 12, 2002

(54) Very narrow band excimer or molecular fluorine laser

(75) Inventors: Jurgen Kleinschmidt, Weissenfels (DE); Peter Heist, Jena (DE); Uwe Stamm, Goettingen (DE); Wolfgang Zschocke, Noerten-Hardenberg (DE); Sergei V. Govorkov, Boca Raton, FL (US)

Correspondence Address: Andrew V. Smith, Sierra Patent Group, Ltd., P.O. Box 6149, Stateline, NV, 89449, US

(73) Assignee: Lambda Physik AG

(21) Appl. No.: 10/114,671

(22) Filed: Apr. 1, 2002

Related U.S. Application Data
(63) Continuation-in-part of application No. 09/712,367, filed on Nov. 14, 2000.
(63) Continuation-in-part of application No. 09/891,928, filed on Jun. 25, 2001, now Pat. No. 6,389,048.
Application No. 09/891,928 is a continuation of application No. 09/172,805, filed on Oct. 14, 1998, now Pat. No. 6,327,284.
Application No. 09/891,928 is a continuation of application No. 09/917,427, filed on Jul. 27, 2001, now Pat. No. 6,404,795.
Application No. 09/917,427 is a continuation of application No. 09/167,657, filed on Oct. 5, 1998, now Pat. No. 6,269,110.
Application No. 09/917,427 is a continuation of application No. 09/629,256, filed on Jul. 31, 2000.
Application No. 09/917,427 is a continuation of application No. 09/923,632, filed on Aug. 6, 2001, now Pat. No. 6,404,796.
Application No. 09/923,632 is a continuation of application No. 09/130,277, filed on Aug. 6, 1998, now Pat. No. 6,285,701.
Application No. 09/923,632 is a continuation of application No. 09/925,041, filed on Aug. 7, 2001.
Application No. 09/925,041 is a division of application No. 09/317,695, filed on May 24, 1999, now Pat. No. 6,345,065.
Application No. 09/925,041 is a division of application No. 09/849,600, filed on May 4, 2001.
Application No. 09/849,600 is a continuation of application No. 09/679,592, filed on Oct. 4, 2000, now Pat. No. 6,272,158.
Application No. 09/679,592 is a continuation of application No. 09/416,344, filed on Oct. 12, 1999, now Pat. No. 6,160,832.
Application No. 09/679,592 is a continuation of application No. 10/035,572, filed on Oct. 18, 2001.
Application No. 10/035,572 is a continuation of application No. 09/718,805, filed on Nov. 22, 2000, now Pat. No. 6,330,267.
Application No. 09/718,805 is a continuation of application No. 09/379,034, filed on Aug. 23, 1999, now Pat. No. 6,212,214.
Application No. 09/718,805 is a continuation of application No. 09/247,887, filed on Feb. 10, 1999.
Application No. 09/718,805 is a continuation of application No. 09/244,554, filed on Feb. 3, 1999, now Pat. No. 6,393,037.
Application No. 09/718,805 is a continuation of application No. 09/657,396, filed on Sep. 8, 2000, now Pat. No. 6,426,966.
Application No. 09/718,805 is a continuation of application No. 09/447,882, filed on Nov. 23, 1999.
Application No. 09/718,805 is a continuation of application No. 09/532,276, filed on Mar. 21, 2000, now Pat. No. 6,456,643.
Application No. 09/532,276 is a continuation-in-part of application No. 09/453,670, filed on Dec. 3, 1999, now Pat. No. 6,466,599.
Application No. 09/532,276 is a continuation-in-part of application No. 09/583,037, filed on May 30, 2000.
Application No. 09/532,276 is a continuation-in-part of application No. 09/602,184, filed on Jun. 22, 2000.
Application No. 09/532,276 is a continuation-in-part of application No. 09/599,130, filed on Jun. 22, 2000, now Pat. No. 6,381,256.
Application No. 09/532,276 is a continuation-in-part of application No. 09/598,552, filed on Jun. 21, 2000, now Pat. No. 6,442,182.
Application No. 09/532,276 is a continuation-in-part of application No. 09/574,921, filed on May 19, 2000, now abandoned.
Application No. 09/574,921 is a continuation-in-part of application No. 09/498,121, filed on Feb. 4, 2000, now abandoned.
Application No. 09/498,121 is a continuation-in-part of application No. 09/694,246, filed on Oct. 23, 2000, now Pat. No. 6,424,666.
Application No. 09/498,121 is a continuation-in-part of application No. 09/741,465, filed on Dec. 18, 2000.
(60) Provisional application No. 60/167,835, filed on Nov. 29, 1999.
(60) Provisional application No. 60/170,342, filed on Dec. 13, 1999.
(60) Provisional application No. 60/121,350, filed on Feb. 24, 1999.
(60) Provisional application No. 60/147,219, filed on Aug. 4, 1999.
(60) Provisional application No. 60/155,188, filed on Jun. 4, 1998.
(60) Provisional application No. 60/126,435, filed on Aug. 18, 1998.
(60) Provisional application No. 60/160,084, filed on Oct. 5, 1998.
(60) Provisional application No. 60/150,683, filed on Aug. 5, 1999.
(60) Provisional application No. 60/212,183, filed on Jun. 16, 2000.
(60) Provisional application No. 60/124,785, filed on Mar. 17, 1999.
(60) Provisional application No. 60/137,907, filed on Jun. 7, 1999.
(60) Provisional application No. 60/140,532, filed on Jun. 23, 1999.
(60) Provisional application No. 60/140,531, filed on Jun. 23, 1999.
(60) Provisional application No. 60/204,095, filed on May 15, 2000.
(60) Provisional application No. 60/162,735, filed on Oct. 29, 1999.
(60) Provisional application No. 60/166,967, filed on Nov. 23, 1999.
(60) Provisional application No. 60/170,342, filed on Dec. 13, 1999.
(60) Provisional application No. 60/162,735, filed on Oct. 29, 1999.
(60) Provisional application No. 60/172,749, filed on Dec. 20, 1999.

(51) Int. Cl. H01S 3/22; H01S 3/223

(52) U.S. Cl. 372/57

(57) ABSTRACT

An excimer or molecular fluorine laser system generates a laser output bandwidth of less than 0.6 pm, and preferably 0.5-0.4 pm or less. The laser resonator has a line-narrowing unit preferably including a grating, and preferably also a beam expander, and may include one or more etalons or other interferometric devices. The grating may be preferably a blazed grating having a blaze angle greater than 76°, and is preferably around 80°. The grating structure is preferably defined by the surface of the grating substrate. The substrate is preferably aluminum. The system may further include an amplifier for increasing the energy of the sub-0.6 nm output beam.

### BACKGROUND OF THE INVENTION

Excimer, molecular, and molecular flourine lasers having a narrowed spectral emission band are particularly useful in microlithography. Narrowed spectral linewidths are desired because minimum feature size and depth of focus in microlithography are limited by chromatic aberrations of projection optics. Examples of such lasers include KrF-, ArF-, XeCl-, XeF- and F₂-lasers, which exhibit output emission wavelengths in the deep ultraviolet (DUV) and the vacuum ultraviolet (VUV) regions of the electromagnetic spectrum. A typical setup of laser systems emitting spectrally narrowed output beams includes a resonator, a discharge chamber filled with a gas mixture and connected to a power supply for generating an output beam, and a wavelength selection module.

Without a wavelength selection unit, the natural output beam of these lasers can be spectrally very broad (e.g., having a linewidth around 500 pm) compared with a linewidth desired for applications in microlithography (around one picometer or less). The linewidth is thus narrowed by the wavelength selection module, which also allows a particular narrow band of wavelengths within the broad band spectrum of the laser to be selected as the output.

A line-narrowed excimer or molecular fluorine laser used for microlithography provides an output beam with specified narrow spectral linewidth. It is desired that parameters of this output beam such as wavelength, linewidth, and energy, energy stability and energy dose stability be reliable and consistent. Narrowing of the linewidth is generally achieved through the use of a linewidth narrowing and/or wavelength selection and wavelength tuning module (hereinafter “line-narrowing module”) consisting most commonly of prisms, diffraction gratings and, in some cases, optical etalons. A line-narrowing module typically functions to disperse incoming light angularly such that light rays of the beam with different wavelengths are reflected at different angles. Only those rays fitting into a certain “acceptance angle” of the resonator undergo further amplification, and eventually contribute to the output of the laser system.

Conventional wavelength selection units exhibit a fixed dispersion or beam expansion meaning that the dispersion or expansion ratio cannot be adjusted during laser operation.

Depending on the type and extent of line narrowing and/or selection and tuning that is desired, and the particular laser that the line-narrowing module is to be installed into, there are many alternative line-narrowing configurations that may be used. According to the extent of line-narrowing that is desired, excimer laser systems can be broadly classified into three general groups: broad-band, semi-narrow band and narrow band.

Broad band excimer lasers do not have any line narrowing modular components. Therefore, the relatively broad (i.e., 300-400 pm) characteristic output emission bandwidth of a KrF or ArF laser, e.g., is outcoupled from the laser resonator of a broad band excimer laser system. FIG. 1A schematically illustrates a typical broad band laser resonator. The laser resonator includes a highly reflective mirror (10), a laser tube (12) having a discharge chamber including a pair of main electrodes (11) connected to a discharge circuit and a preionization unit (not shown) and containing a gain medium, and a partially transmissive outcoupler (14) for outcoupling the beam (16).

A semi-narrow band laser has a characteristic output that is line-narrowed using most typically a dispersive prism or gratings. The dispersive prism or prisms are typically located between the discharge chamber and a highly reflective resonator reflector. On the other side of the laser chamber is typically a partially reflective output coupler. The output emission bandwidth of the semi-narrowed laser is reduced for a KrF or ArF laser, e.g., from around 300 pm to less than 100 pm. The semi-narrow band laser may be used in combination with catadioptric (reflective) optical imaging systems for industrial photolithography. The absence of refractive optics and associated chromatic aberrations in catadioptric imaging systems permits the linewidths of semi-narrow band lasers to be sufficient, and permit semi-narrow band lasers to be satisfactory radiation sources for photolithographic applications.

FIG. 1B schematically illustrates an example of a semi-narrow band laser. The laser includes a highly reflective mirror (10), a laser tube (12) and an outcoupler (14) for outcoupling the beam (16). A dispersive prism (18) is inserted into the resonator between the laser tube (12) and the highly reflective mirror (10). An aperture (19) is also shown inserted between the laser tube (12) and the outcoupler (14) which may serve to reduce the acceptance angle of the resonator and further reduce the output emission bandwidth.

A narrow band laser that typically has a far greater dispersive power that the dispersive prisms referred to above further includes a grating. The line-narrowing unit may comprise a Littrow configuration of beam expanding prisms and a grating. The grating used is typically an echelle-type blazed reflection grating having a blaze angle around 76°. The most significant factor in the line narrowing of this system is the dispersive power of the grating. Preferably, a plurality of beam expanding prisms are used to magnify the beam, thus reducing the beam divergence by the same magnification factor, and contributing to the narrowing of the bandwidth by spreading the beam over a larger area of the grating. One or more etalons may also be added for further line narrowing, for instance, either just before the grating, or between the prisms, or as an outcoupler. There are other related techniques described in the patents and patent applications referenced above. Such techniques are used to narrow the linewidth to below 1 pm. As such, narrow band lasers are used in combination with refractive optical imaging systems.

A fourth classification, very narrow band, is sometimes referred to when it is desired to distinguish those lasers in the narrow band group that have a particularly very narrow output emission bandwidth (e.g., <0.6 pm). For instance, a typical narrow band KrF excimer laser emitting around 248 nm or an ArF laser emitting around 193 nm has a line-narrowing unit capable of reducing the bandwidth to between 0.8 pm and 0.6 pm. To improve the resolution of the projection optics, an even narrower laser bandwidth is desired. It is particularly desired to have excimer and molecular fluorine laser systems of high reliability and a very small bandwidth of less than 0.6 pm and particularly still as low as 0.4 pm or less.

There are restrictions on conventional laser resonators preventing achievement of very narrow bandwidths of <0.6 pm, while maintaining other parameters such as pulse energy, pulse repetition rate or lifetime of optical components. One of these restrictions is a limitation on the expansion ratio or magnification of the beam expander. The expansion ratio is limited by a limitation on size of the prisms that can practically be used in the beam expander due to the magnitude of wavefront distortions introduced particularly by larger prisms.

Another restriction is that reduction of the width of slit apertures in the resonator is limited by energy considerations. That is, below some minimum slit aperture width, the output energy of the laser would be insufficient.

Increasing the finesse of an etalon in the resonator is limited by a reduction in transmissivity of the etalon with increased finesse. Below some minimum transmissivity of the etalon, the resonator losses incurred are not tolerable.

In the '520 patent, mentioned above, a laser resonator is described for generating output pulses having a bandwidth of 0.8 pm. The bandwidth of the pulses described in the '520 patent can be reduced further to as low as 0.6 pm bandwidth by precise modification of certain laser specifications. These modifications include adjusting the composition of the gas mixture, the degree of output coupling, the material of prisms and the length of the electrodes.

In the '991 patent, mentioned above, a laser resonator is described as providing pulses having a bandwidth of 0.5 pm or less using an etalon output coupler, i.e., in place of the typical partially reflective mirror output coupler. The addition of an etalon output coupler in the resonator, however, results in a complex resonator because the etalon outcoupler would require special, complicated fine tuning, such as by pressure tuning or using piezoelectric actuators.

As mentioned above, diffraction gratings have been incorporated into lasers in order to provide spectrally narrowed output beams. A diffraction grating typically includes a plate or film with a series of closely spaced lines or grooves (typically many thousands per inch/hundreds per mm). Diffraction gratings are usually planar but gratings with other profiles are often used where required by the application (e.g., spectroscopes). See also U.S. Pat. No. 5,095,492. Diffraction gratings may also be formed in a volume of material.

Diffraction gratings, their design and construction are described in E. G. Loewen and E. Popow in Diffraction Gratings and Applications (Marcel Dekker, 1997) as well as in U.S. Pat. Nos. 5,999,318 (Morton et al.) and 5,080,465 (Laude). Each of these three references is incorporated herein by reference in its entirety. Diffraction gratings may be made by actually engraving each line individually using a very precise ruling or etching mechanism. These ruled gratings generally are of very high quality and very expensive. Typically, such gratings are used as masters from which copy or replica gratings are made. Replica gratings are practically as serviceable while being substantially less inexpensive. The interference between a pair of laser beams can also be used to directly generate holographic gratings. This technique allows gratings with more complex arbitrary shapes and designs to be manufactured.

Usually, the substrates for the gratings are made of special glasses or ceramics, such as ULE™ and Zerodure™. In one design, a diffraction grating would have a thin layer of epoxy with a thickness of about 12 to 40 microns over the substrate surface. The epoxy layer would have a diffraction grating incorporated as part of its structure as the result of a replica process. The epoxy surface would then in turn be coated by an aluminum layer on the order of 10-30 microns thick. Aluminum absorbs more than 10% of the radiation in the DUV spectral region within a very thin layer thickness. An additional layer of a dielectric material might also be added to the outer surface of the aluminum layer.

The '465 and '318 patents also teach the manufacture and use of diffraction gratings having at least three layers as shown in FIG. 2: a thin aluminum reflective upper layer (72), an epoxy intermediate layer (74), and a glass substrate (76). Optionally, there may also be a dielectric coating (78) above the thin aluminum layer (72). While the thin aluminum layer (72) provides a reflective surface, which is relatively impervious to the intense light of a laser beam, the laser beam can damage the underlying epoxy layer. Any discontinuity in the thin aluminum layer allows the laser light to penetrate to the underlying epoxy layer which is then subject to photodecomposition reactions and consequential degradation of its diffractive properties. This damage substantially limits the lifetime of a diffractive grating and therefore undesirably increases the down time of the laser.

To increase the lifetime and optical stability of a diffraction grating, the epoxy substrate needs to be protected from such photodecomposition. The '318 patent discloses application of a protective aluminum overcoat of approximately 100 nm thickness over the thin aluminum reflective layer. The overcoat is applied under vacuum conditions by sputtering aluminum or deposition of aluminum vapor onto the reflective aluminum layer after it has been separated from the master. It is thought that the discontinuities or fractures in the reflective aluminum layer are formed during separation of the aluminum layer from the master. This overcoat of aluminum protects the epoxy layer from any discontinuities of the thin aluminum reflective layer and provides a diffraction grating with an enhanced optical stability and use lifetime.

The intense energies of the laser beam are associated with a great deal of heat energy resulting from even a relatively small absorption of the intense laser light by matter. The rate at which heat energy is carried away from the diffraction grating having an aluminum, epoxy and glass layer is primarily limited by the thermal conductivities of the epoxy and glass layers which are substantially less than that of aluminum.

The performance of a diffraction grating is sensitive to temperature changes. For instance, temperature changes, particularly nonuniform changes in the temperature, may distort the wavefront of a back reflected laser beam due to heat related distortions in the grating structure. Temperature changes distort surface flatness to adversely affect bandwidth. Temperature changes also variably alter the distance of the grating lines from each other to produce a wavelength shift.

If a wavelength shift of less than 0.1 pm is required, the maximum variation in the temperature of the grating is given by the formula: δT≦(δλ)/α. In this formula, δT represents the temperature variation, δλ represents the wavelength shift, and α represents the coefficient of linear thermal expansion of the substrate of the grating.

The photon energy of a laser can be quite high, especially for excimer, molecular, or molecular flourine laser operating in the UV region. For instance, a KrF laser operating around 248 nm generates photons of about 5 eV; an ArF laser operating around 193 nm generates photons of about 6.4 eV; and a F₂ laser operating around 157 nm generates photons of about 7.9 eV. Photons with these energy levels are capable of breaking the molecular bonds of the epoxy substrate. In addition, the epoxy layer is subject to thermal decomposition. Thus, there is a need for a more temperature and laser beam resistant diffraction grating for use in lasers, especially for highly dispersive diffraction gratings incorporated into a line narrowing module.

Vacuum-UV microlithography takes advantage of the short wavelength of the molecular fluorine laser (157.6 nm), which allows the formation of structures of 0.1 mm or below by photolithographic exposure on semiconductor substrates. TFT annealing and micro-machining applications may also be performed advantageously at this wavelength.

Given the limited choice of high quality optical materials available in this wavelength range for manufacturing imaging lenses, requirements of minimal chromatic aberrations restrict spectral linewidths of the laser source for refractive and partially achromatic imaging systems to below 1 pm. The expectation is that spectral linewidths be between 0.1 pm and 0.2 pm, and perhaps even below 0.1 pm in the future. Conventional molecular fluorine lasers emit VUV beams having spectral linewidths of greater than 1 pm.

A disadvantage of narrowing of spectral linewidth in a laser is that it commonly leads to a significant decrease of efficiency and output power. Therefore, it is recognized in the present invention that to achieve a desired high throughput for 157 nm wafer steppers or wafer scanners, it would be advantageous to have a line-narrowed molecular fluorine laser emitting an output beam of less than 1 pm, with a high output power that averages anywhere from several watts to more than 10 watts.

### SUMMARY OF THE INVENTION

A method of forming a diffraction grating in the surface of a substrate is provided including generating an ion beam, patterning the ion beam, and impinging the patterned beam onto the surface to thereby form the grating therein. The patterning may include passing the beam through an attenuator having a structure according to the structure of the grating. The attenuator may be substantially made of epoxy.

A method of forming a diffraction grating in the surface of a substrate is further provided including providing an ion beam, attenuating the ion beam according to the structure of the diffraction grating, and irradiating the surface with the attenuated beam. The attenuated ion beam forms the grating in the surface.

An excimer or molecular fluorine laser is also provided including an oscillator and an amplifier. The oscillator includes a laser tube including a discharge chamber filled with a laser gas mixture at least including molecular fluorine and a buffer gas, multiple electrodes in the discharge chamber connected to a discharge circuit for energizing the gas mixture, a resonator surrounding the gas mixture for generating a laser beam, and a line-narrowing unit for narrowing the bandwidth of said laser, wherein the line-narrowing unit includes a grating and narrows the bandwidth to less than 0.6 pm-0.4 pm or less. The amplifier increases the energy of the sub-0.6 pm laser beam for industrial application such for photolithography.

The grating may have a blaze angle of at least 78°, such as between 78° and 82°, and may be substantially 80° or more. The grating may have a coating comprising a reflective dielectric material. The grating have 10,000 grooves per centimeter or more.

Many additional advantageous features are set forth in the priority applications enumerated above, and in the detailed description below and in the drawings.

### BRIEF DESCRIPTION OF THE DRAWINGS

FIG. 1A schematically illustrates a broad band laser resonator.

FIG. 1B schematically illustrates a semi-narrow band laser resonator.

FIG. 2 schematically illustrates a diffraction grating having a grid structure formed in an epoxy layer attached to a substrate.

FIG. 3A schematically illustrates a laser resonator in accord with a first embodiment of the present invention.

FIG. 3B schematically illustrates a laser resonator in accord with a second embodiment of the present invention.

FIG. 4A schematically illustrates a first line-narrowing unit in accord with the present invention.

FIG. 4B schematically illustrates a second line-narrowing unit in accord with the present invention.

FIG. 5 schematically illustrates a grating having a blaze angle greater than 76° in accord with the present invention.

FIGS. 6A-6D schematically illustrate several diffraction gratings having a grid structure formed within the surface of the substrate/rigid base body.

FIGS. 7A-7B schematically illustrate how to use ion beams to form a diffraction grating within the surface of a substrate/rigid base body.

FIG. 8 is a schematic block diagram of a preferred narrow band or very narrow band laser according to the invention.

FIG. 9 schematically illustrates a molecular fluorine laser system in accord with a preferred embodiment.

FIGS. 10a-10f schematically show several alternative embodiments in accord with a first aspect of the invention including various line narrowing resonators and techniques utilizing line-narrowed oscillators for the molecular fluorine laser.

FIG. 11a schematically shows a preferred embodiment in accord with a second aspect of the invention including an oscillator, a spectral filter in various configurations, and an amplifier.

FIGS. 11b-11d schematically show alternative embodiments of spectral filters in further accord with the second aspect of the invention.

FIG. 12a schematically shows an alternative embodiment in accord with the second aspect of the invention including a single discharge chamber providing the gain medium for both an oscillator and an amplifier, and having a spectral filter in between.

FIGS. 12b(i)-(iii) respectively show waveforms of the electrical discharge current, un-narrowed beam intensity and output beam intensity in accord with the alternative embodiment of FIG. 3a.

FIG. 13a schematically shows a preferred embodiment in accord with a third aspect of the invention including a line-narrowed oscillator followed by a power amplifier.

FIGS. 13b-13f schematically show alternative embodiments of line-narrowed oscillators in further accord with the third aspect of the invention.

FIGS. 14a-14b schematically show alternative embodiments in accord with a fourth aspect of the invention including a single discharge chamber providing the gain medium for both an oscillator with line-narrowing and an amplifier.

FIG. 15 schematically illustrates a ventilation system for an excimer or molecular fluorine laser system.

FIG. 16 schematically illustrates a dispersion prism for use with a line-narrowing unit of an excimer or molecular fluorine laser system.

FIGS. 17a-17b schematically illustrates an excimer or molecular fluorine laser system including wavelength calibration.

FIG. 18 schematically illustrates a corona preionization for an excimer or molecular fluorine laser system.

FIG. 19 schematically illustrates a sliding surface preionization for an excimer or molecular fluorine laser system.

FIG. 20 schematically illustrates a pair of spoilers and main electrode shapes for an excimer or molecular fluorine laser system.

FIG. 21 schematically illustrates a grism within a resonator of an excimer or molecular fluorine laser system.

FIG. 22 schematically illustrates an extracavity beam enclosure system for a VUV laser.

FIG. 23 schematically illustrates a resonator including an anti-speckle plate for an excimer or molecular fluorine laser system.

FIG. 24 schematically illustrates peaking and sustaining capacitors of a final stage of a pulsed discharge circuit of an excimer or molecular fluorine laser system.

FIG. 25 schematically illustrates an excimer or molecular fluorine laser system including bema simulation optics before a diagnostic detector for simulating the effect of beam transforming optics before a workpiece.

### INCORPORATION BY REFERENCE

What follows is a cite list of references each of which is, in addition to the background, summary of the invention, abstract and claims, hereby incorporated by reference into the detailed description of the preferred embodiments below, as disclosing alternative embodiments of elements or features of the preferred embodiments. A single one or a combination of two or more of these references may be consulted to obtain a variation of the preferred embodiments described in the detailed description below. Further patent, patent application and non-patent references are cited in the written description and are also incorporated by reference into the preferred embodiment with the same effect as just described with respect to the following references:

U. Stamm, “Status of 157 nm The 157 Excimer Laser” International SEMATECH 157 nm Workshop, Feb. 15-17, 1999, Litchfield, Ariz., USA;

T. Hofman, J. M. Hueber, P. Das, S. Scholler, “Prospects of High Repetition Rate F₂ (157 nm) Laser for Microlithography”, International SEMATECH 157 Workshop, Feb. 15-17, 1999, Litchfield, Ariz., USA;

U. Stamm, I. Bragin, S. Govorkov, J. Kleinschmidt, R. Patzel, E. Slobodtchikov, K. Vogler, F. Voss, and D. Basting, “Excimer Laser for 157 nm Lithography”, 24^{th} International Symposium on Microlithography, Mar. 14-19, 1999, Santa Clara, Calif., USA;

T. Hofmann, J. M. Hueber, P. Das, S. Scholler, “Revisiting The F₂ Laser For DUV microlithography”, 24^{th} International Symposium on Microlithography, Mar. 14-19, 1999, Santa Clara, Calif., USA.

W. Muckenheim, B. Ruckle, “Excimer Laser with Narrow Linewidth and Large Internal Beam Divergence”, J. Phys. E: Sci. Instrum. 20 (1987) 1394;

G. Grunefeld, H. Schluter, P. Andersen, E. W. Rothe, “Operation of KrF and ArF Tunable Excimer Lasers Without Cassegrain Optics”, Applied Physics B 62 (1996) 241;

W. Mueckenheim, “Seven Ways to Combine Two Excimer Lasers,” reprinted from July 1987 edition of Laser Focus/Electro-Optics; and

Erwin G. Loewen and Evgeny Popov, “Diffraction Gratings and Applications”, pp 1-588 (1997);

U.S. Pat. Nos. 6,061,382, 6,081,542, 5,559,816, 6,298,080, 6,345,065, 6,327,290, 5,761,236, 6,212,217, 4,616,908, 5,051,558, 5,221,823, 5,440,578, 5,450,436, 5,559,584, 5,590,146, 5,763,855, 5,811,753, 6,219,368, 6,154,470, 6,157,662, 6,219,368, 5,150,370, 5,596,596, 5,642,374, 5,559,816, 5,852,627, 6,005,880, and 5,901,163; and

U.S. published patent application no. 20020006147; and

U.S. patent application Ser. Nos. 09/712,877, 09/598,552, 09/727,600, 09/131,580, 09/602,184, 09/599,130, 09/629,256, 09/640,595, 09/694,246, 09/771,366, 09/738,849, 09/715,803, 09/712,367, 09/717,757, 09/843,604, 09/584,420, 09/883,127, 09/883,128, 09/657,396, 09/453,670, 09/447,882, 09/512,417, 09/695,246, 09/712,877, 09/574,921, 09/718,809, 09/733,874 and 09/780,124, Nos. 60/267,567, 60/212,257, Ser. Nos. 09/791,431, 09/771,013 and 09/883,097, which are assigned to the same assignee as the present application; and

WO 01/18923; and

EP 1 017 086 A1 and EP 0 472 727 B1; and

JP 2,696,285.

U.S. patent applications no., which are assigned to the same assignee as the present application; and

K. Vogler, “Advanced F2-laser for Microlithography”, Proceedings of the SPIE 25th Annual International Symposium on Microlithography, Santa Clara, Feb. 28-Mar. 3, 2000, p. 1515.

### DETAILED DESCRIPTION OF THE PREFERRED EMBODIMENT

Methods and apparatuses are provided in accord with preferred embodiments, such as a narrow band molecular fluorine or excimer laser system including an oscillator and an amplifier, wherein the oscillator produces a 157 nm, 193 nm, or 248 nm beam having a linewidth less than 1 pm and the amplifier increases the power of the beam above a predetermined amount, such as more than one or several Watts. The oscillator includes a discharge chamber filled with a gas mixture including molecular fluorine and a buffer gas, as well as an active rare gas for the excimer lasers, main and preionization electrodes within the discharge chamber connected to a discharge circuit for energizing the gas mixture, and a resonator including the discharge chamber and line-narrowing optics for generating the laser beam having a wavelength around 157 nm, 193 nm or 248 nm and a linewidth less than 1 pm.

The amplifier preferably comprises a discharge chamber filled with a gas mixture including molecular fluorine and a buffer gas, as well as an active rare gas for the excimer lasers, electrodes connected to the same or a similar discharge circuit, e.g., using an electrical delay circuit, for energizing the molecular fluorine. The amplifier discharge is timed to be at or near a maximum in discharge current when the pulse from the oscillator reaches the amplifier discharge chamber.

The line-narrowing optics may include one or more etalons tuned for maximum transmissivity or reflectivity, depending on whether the interferometric device is configured as a resonator reflector or to be disposed between the resonator reflector pair of the laser system, of a selected portion of the spectral distribution of the beam, and for relatively low transmissivity or reflectivity of outer portions of the spectral distribution of the beam. A prism beam expander may be provided before the interferometric devices for expanding the beam incident on the etalon or etalons. Two etalons may be used and tuned such that only a single interference order is selected.

The line-narrowing optics preferably include a grating, which may be for selecting a single interference order of the interferometric device(s) corresponding to the selected portion of the spectral distribution of the beam, or may perform line-selection and or line-narrowing without an etalon or other interferometric device. The resonator further preferably includes an aperture within the resonator, and particularly between the discharge chamber and the beam expander. A second aperture may be provided on the other side of the discharge chamber.

The line-narrowing optics may include no etalon. For example, the line optics may instead include only a beam expander and a diffraction grating. The beam expander preferably includes two, three or four VUV and/or DUV transparent prisms before the grating. The grating preferably has a highly reflective surface for serving as a resonator reflector in addition to its role of dispersing the beam.

The line-narrowing optics may include an interferometric output coupler tuned for maximum reflectivity of a selected portion of the spectral distribution of the beam, and for relatively low reflectivity of outer portions of the spectral distribution of the beam. This system would also include optics such as a grating, dispersive prism and/or other interferoemtric device, preferably following a beam expander, for selecting a single interference order of the interferometric output coupler. The resonator would preferably have one or more apertures for reducing stray light and divergence within the resonator.

In any of above configurations including a grating, a highly reflective mirror may be disposed after the grating such that the grating and HR mirror form a Littman configuration. Alternatively, the grating may serve to retroreflect as well as to dispserse the beam in a Littrow configuration. A transmission grating or grism may also be used.

The buffer gas preferably includes neon and/or helium for pressurizing the gas mixture sufficiently to increase the output energy for a given input energy and to increase the energy stability, gas and tube lifetime, and/or pulse duration. The laser system further preferably includes a gas supply system for transferring molecular fluorine into discharge chamber and thereby replenishing the molecular fluorine, therein, and a processor cooperating with the gas supply system to control the molecular fluorine concentration within the discharge chamber to maintain the molecular fluorine concentration within a predetermined range of optimum performance of the laser.

The laser system may include an amplifier for increasing the energy of the beam which may have a bandwidth reduced to less than 0.6 pm, and may also include a spectral filter between the oscillator and the amplifier for further narrowing the linewidth of the output beam of the oscillator. The spectral filter may include an etalon or etalons following a beam expander. Alternatively, the spectral filter may include a grating for dispersing and narrowing the beam. In the grating embodiment, the spectral filter may include a lens focusing the beam through a slit and onto a collimating optic prior to impinging upon the beam expander-grating combination.

An excimer or molecular fluorine laser in acorance with a preferred embodiment is provided for generating a laser output bandwidth of less than 0.6 pm, preferably of less than 0.5 pm, and more preferably 0.4 pm or less. The laser resonator preferably includes a laser tube surrounded by a resonator including a line-narrowing unit and an outcoupler. The line-narrowing unit preferably includes a beam expander and a grating, and may include one or more etalons or other interferometric device(s) (see U.S. patent application Ser. No. 10/081,883, which is assigned to the same assignee as the present application and is hereby incorporated by reference). The grating is advantageously configured to provide enhanced dispersion for reducing the bandwidth in accord with the preferred embodiment. The grating may be a blazed grating having a blaze angle greater than 76°. The blaze angle is preferably particularly greater than 78°, and more particularly greater than 80°. For example, the blaze angle may be between 78° and 82°, and more preferably around 81°. The grating is preferably an echelle type reflection grating, and as such, serves also as a highly reflective resonator reflector.

The line narrowing unit preferably has a diffraction grating with an advantageously high damage threshold with respect to laser beam radiation and heat associated with laser beam narrowing. This preferred grating is defined within the surface of the grating substrate/rigid base body such that the substrate and grating are substantially formed from a single material which has high thermal conductivity and is resistant to the destructive action of prolonged exposure to intense laser beam energy. This grating therefore has an advantageously high damage threshold owing to the definition of the grating structure by the substrate surface. In some embodiments, this grating is preferably has a coating of reflective dielectric material. The grating disperses and reflects portions of the incident beam and is resistant to the energy associated therewith.

The outcoupler is preferably a partially transmissive mirror, and preferably is positioned on the opposite side of the laser tube as the line-narrowing unit. Alternatively, outcoupling may be performed by reflecting a component, such as a polarization component, of the beam from a surface of a prism or other optical surface, and the resonator may be a polarization coupled resonator (PCR). A polarization rotator is preferably used in this alternative resonator configuration. The laser tube includes a discharge chamber filled with a laser gas mixture and having a plurality of electrodes connected to a discharge circuit for energizing the gas mixture.

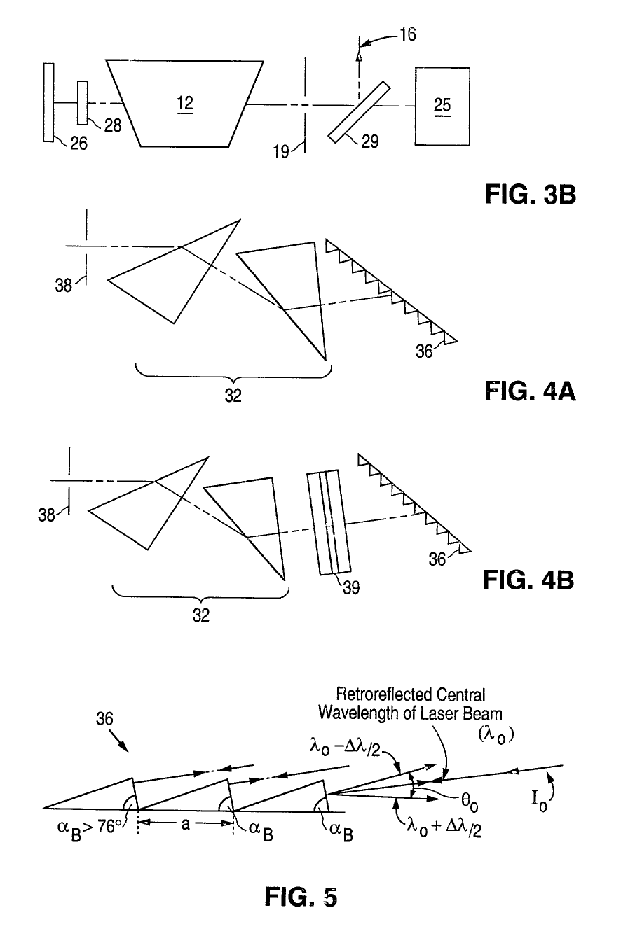

FIG. 3A schematically illustrates a first laser resonator configuration for an excimer or molecular fluorine laser in accord with the present invention. The resonator design shown in FIG. 3A includes a laser chamber or laser tube (12) containing a laser gas mixture and having a pair of main electrodes (11) and one or more preionization electrodes (not shown) connected to a discharge circuit including a power supply and pulser circuit for energizing the gas mixture. Preferred circuits (not shown) and circuit components such as main and preionization electrodes are described at U.S. patent application Ser. Nos. 08/842,578, 08/822,451, 09/390,146, 09/247,887, Nos. 60/128,227 and 60/162,645, each of which is assigned to the same assignee as the present application and which is hereby incorporated by reference.

The resonator further includes a line-narrowing unit (25), a slit aperture (19) and a partially transmissive outcoupling mirror or resonator reflector (14). More than one aperture or no aperture may be included, and the aperture or apertures may be located in various positions within the resonator including either side of the laser tube (12). Preferred aperture designs and configurations are described at U.S. Pat. No. 5,161,238 and U.S. patent application Ser. No. 09/130,277, each of which is assigned to the same assignee as the present application and hereby incorporated by reference. A wavelength monitor and stabilization device is included in the laser system (although not shown) and the preferred system is described at U.S. Pat. No. 4,905,243 and U.S. patent application Ser. No. 09/416,344, each of which is assigned to the same assignee, and U.S. Pat. Nos. 5,420,877, 5,450,207, 5,978,391 and 5,978,394, all of which are hereby incorporated by reference. The line-narrowing unit is described in detail below with reference to FIGS. 4A-4B and FIG. 5.

FIG. 3B schematically illustrates a second resonator configuration in accord with the present invention. The resonator of FIG. 3B includes a laser tube (12) and aperture (19) as described above, and a line-narrowing unit (25) (as mentioned, to be described in detail below). The resonator of FIG. 3B also includes a highly reflective mirror or resonator reflector (26), a polarization rotator (28) and a polarizing beam splitter (29). The polarization rotator (28) in front of the highly reflective mirror (26) and the polarizing beam splitter (29) work together to outcouple a polarization component of the beam. Thus, there is no partially transmissive outcoupler in the resonator of FIG. 3B, and the line-narrowing unit (25) also includes a highly reflective component such as a highly reflective grating. A surface of another optical component such as a prism, angled window of the laser tube or tilted etalon may be used to outcouple the beam instead of the beam splitter (29).

FIGS. 4A-4B schematically illustrate two preferred line-narrowing units (25) for use with the first and second resonator arrangements shown in FIGS. 3A-3B. Another line-narrowing unit that can be used to provide a very narrow bandwidth would include a prism beam expander, one or more etalons and a highly reflective mirror, but no grating. However, more preferred embodiments of the present invention each have a grating, as shown in FIGS. 4A-4B.

The line narrowing-unit of FIG. 4A includes a prism beam expander (32), a grating (36) and an optional aperture (38). The prism beam expander (32) shown includes two beam expanding prisms, but the beam expander (32) may comprise a different number of beam expanding prisms such as one or more than two. A dispersion prism may also be included. Alternatively, another beam expander may be used such as a lens configuration including a diverging and a converging lens. The beam expansion prisms may each comprise CaF₂, or fused silica, or the prisms may comprise one each of fused silica and CaF₂, or the prisms may comprise another material having similar properties such as absorption coefficient, thermal expansion and resistance to thermal stress at the laser wavelengths and repetitions being used (e.g., 248 nm, 193 nm and 157 5 nm, and 1 kHz or more). Preferred beam expanders are set forth at U.S. Pat. No. 5,761,236, and U.S. patent application Ser. No. 09/244,554, each of which is assigned to the same assignee, and U.S. Pat. No. 5,898,725, all of which are hereby incorporated by reference. The grating is described in more detail below with reference to FIG. 5.

FIG. 4B shows a second preferred line-narrowing unit for use with either of the first or second preferred resonator arrangements shown in FIGS. 3A-3B. The line-narrowing unit shown in FIG. 4B includes a prism beam expander (32) (as discussed above with respect to FIG. 4A), an etalon (39), a grating (36) and an optional aperture (38). The preferred etalon is described at U.S. patent application No. 60/162,735, Ser. Nos. 09/317,695 and 09/317,527, each of which is assigned to the same assignee and is hereby incorporated by reference. More than one such etalon may be included.

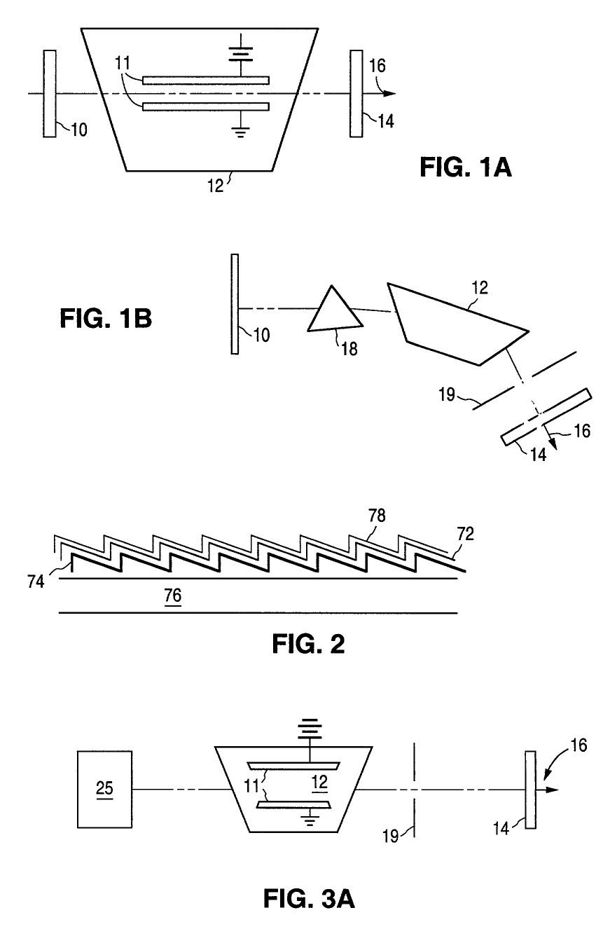

A preferred grating (36) is shown in FIG. 5. This preferred grating may be included in the line narrowing units of each of the preferred line-narrowing units of FIGS. 4A-4B. The grating dimensions of any of the FIGS. 1-8 are not drawn to scale. The separation of grooves is related to the wavelength of the light to be reflected by the grating and the narrowness of the range of wavelengths it is required to reflect. Gratings may have grooves on the order of tens of thousand per cm. An incident beam I₀ reflects from the surface of the grating, as shown. Preferred distance, or separation, between grooves, d, is governed by formulae that are well known in the art (e.g., d·(sin I+sin R)=N_{DO}λ, where I is the angle of the incident beam to the grating surface, R is the angle of the reflected beam, λ is the wavelength of the beam, and N_{DO} is according to the diffraction order number. For retroreflected beams, as at the blaze angle (α_{b}), the incident and reflective angles are the same. Thus, the formula reduces at the blaze angle condition to d·2(sin α_{b})=N_{DO} λ). The grating (36) preferably has a line groove density of 1/d. The beam I₀ impinges upon the grating (36) and the rays reflect from the grating (36) according to the standard grating formula. That is, the beam is dispersed by the grating (36) such that light rays incident at the grating (36) reflect at unique angles depending on their particular wavelengths. The wavelengths around a central wavelength λ₀ are retroreflected back into the laser resonator, as shown in FIG. 5.

Only those rays having wavelengths within the acceptance range of angles θ₀ of the laser resonator will be included in the output emission beam of the laser system. The range of wavelengths that will be retroreflected back into the laser tube is λ₀−Δλ/2 to λ₀+Δλ/2. Thus, the wavelength range has a breadth Δλ that will determine ultimately the bandwidth or linewidth of the output emission beam of the laser (see below). The central wavelength within the band is λ₀ which is separately controlled preferably by orienting the grating (36) at a particular selected angle with respect to the incident beam.

The angular acceptance range θₒ is fixed by the resonator and discharge width independently of the dispersion of the grating. Thus, the wavelength range Δλ which ultimately determines the output bandwidth of the laser beam may be adjusted by adjusting the dispersion of the grating (36) based on the formula:

θ₀≈dα/dλ·Δλ (1),

where dα/dλ is the dispersion of the grating (36).

The passive bandwidth or single-pass bandwidth generated by a grating in Littrow configuration (shown schematically in FIG. 4A) is particularly described by the following equation:

Δλ′=λ₀·ΔΘ/[2·tan(α_{B})] (2),

where Δλ′ is the bandwidth, λ₀ is the central wavelength of the output emission beam of the laser, α_{B} is the blaze angle of the grating (36) used in Littrow configuration, tan (α_{B}) corresponds to the dispersion of the grating (36) in Littrow configuration, and ΔΘ is the beam divergence.

The final bandwidth Δλ″ after n passes or round trips through the resonator for a gaussian line shape is approximately given by:

Δλ″≈Δλ′/(n)^{1/2} (3).

An observation of equations (2) and (3) reveals that the bandwidth Δλ″ can be adjusted (i.e., reduced) in the following ways:

1. decrease the beam divergence ΔΘ;

2. increase the grating dispersion (tan (α)); and/or

3. increase the number of round trips, n.

Decreasing the divergence according to item 1 is possible by increasing the magnification of the prism beam expander (32) of FIG. 4A (or FIG. 4B). The expansion by magnification factor M reduces the beam divergence by the same factor M. However, this is one of the restricted techniques discussed above. That is, increasing the expansion ratio of the beam expander is limited because wavefront distortions due to imperfections at the surfaces of the prisms will substantially inhibit successful bandwidth narrowing effort beyond a certain magnification M. It is preferred that the magnification M be maximized in accord with this restriction, but the desired narrow bandwidth is not fully achieved in this way according to the present invention.

Increasing the number of round trips in accord with item 3 is also preferred in accord with the present invention. For example, the gas mixture composition should be optimized (particularly the halogen concentration is the gas mixture) as well as the degree of outcoupling by the outcoupler (components 14 and 29 of FIGS. 3A and 3B, discussed above) (see the '520 patent referred to above). However, the pulsed discharge mode of the laser has a short lifetime of gain medium inversion (in the range of <100 nanoseconds). Thus, increasing the number of round trips, n, is limited by this short inversion lifetime, and, as with item 1, the desired bandwidth is not fully realized in accord with the present invention in this way either, i.e., by maximizing the number of round trips.

An optimized resonator of the type as shown schematically in FIG. 3A, and in accord with items 1 and 3 above produced a bandwidth around 0.6 pm; not yet fully in accord with the objects of the invention. The grating used was an echelle type grating having tan(α)=5 (known as a R5-grating). The slit width of the aperture (19) was optimized in accord with the '277 application mentioned above. The preferred slit width of the aperture (19) is 1-2 mm. The number and type of prisms in the beam expander (32) was also optimized, and may generally vary depending on the laser system and specifications of the industrial application. In addition, the output pulse energy was around 10 mJ, the energy stability was a deviation around <3%, the dose stability has a deviation around <0.5%, and the repetition rate was around 2 kHz, in accord with typical specifications delivered requested by stepper/scanner manufacturers.

Increasing dispersion in accord with item 2 advantageously allows the desired narrow bandwidth to be achieved in accord with the present invention. This increased dispersion is achieved in accord with the present invention by using a grating (36) having a blaze angle greater than 76°. By using a grating (36) having a blaze angle greater than 76° with the line-narrowing unit of either FIG. 4A or 4B, an object of the invention set forth above is met, i.e., providing an excimer or molecular fluorine laser with a bandwidth less than 0.6 pm. By using a grating (36) having a blaze angle greater than 80°, the second object of the invention is met, i.e., an excimer laser is achieved having an output emission bandwidth of 0.4 pm or less. The third object is also met because no fine-tuning of an optical element such as an etalon outcoupler is necessarily performed to achieve the desired very narrow bandwidth.

The particularly preferred grating (36) for use with a line-narrowing unit (25) in accord with the present invention is a specially designed R6.5-grating (i.e., tan(α)˜6.5). The blaze angle of this grating is about 81°. With this resonator configuration including a preferred grating (36) having a blaze angle around 81°, a bandwidth less than 0.4 pm was achieved with an excimer laser. The measured bandwidth was around 0.3 pm. The spectral purity of the laser beam was less than 2.0 pm.

It is recognized that there is an upper limit on how much the blaze angle can be increased to achieve advantageously narrower bandwidths in accord with the present invention. For example, clearly the grating (36) cannot have a blaze angle of 90°, and thus the blaze angle α_{B} of a grating (36) in accord with the present invention will be less than 90°. There is a real limit that is still less than 90° and may be 86°-87°. Although it may be difficult to manufacture a grating (36) having a blaze angle as high as 86°-87°, one skilled in the art would understand that it is possible to make them. Thus, these higher gratings also may be advantageously used with an excimer laser in accord with the present invention.

The preferred embodiments achieve an excimer or molecular fluorine laser having a very narrow output emission bandwidth Δλ″ by increasing the dispersion dα/dλ of the grating (36). This increasing of dα/dλ of the grating (36) is achieved by increasing the blaze angle α_{B} of the grating (36) from the typical blaze angle around 75°-76° to more than 76°. Preferably, the blaze angle of the grating (36) is more than 78°, and more preferably the blaze angle of the grating (36) is more than 80°. It is specifically preferred to have a blaze angle around 81°, in accord with the present invention.

The present invention provides a very narrow band excimer laser having a resonator as efficient and simple as possible resulting in a laser system of high reliability. The laser system of the present invention meets the above objects and the demands of stepper/scanner manufacturers who desire an excimer laser having line-narrowing capability such that a laser output beam may be provided having a bandwidth of 0.4 pm or less.

A preferred grating has a substrate having a surface upon which the grating structure is preferably machined or etched directly. The grating surface is preferably coated by a highly UV reflecting layer system of dielectric material or an aluminum layer with an UV reflection enhancing dielectric coating or coating system or an aluminum layer with a dielectric protecting layer. This structure is much more stable against heating and aging effects associated with increased dispersion of laser radiation. This resistance is largely due to the absence of the organic epoxy layer which can be adversely affected by heat and UV radiation. If the body of the grating is made of metal, a second advantage is the high thermal conductivity of the grating body compared to glass or ceramic which minimizes the generation of thermal gradients. Preferably, the temperature of the grating has to be kept constant within the constraints of the thermal expansion expression: δT≦(δλ)/α.

A dielectric reflecting layer provides a preferred grating that has a higher UV reflectivity and a greater lifetime as compared to a pure aluminum surface layer without the dielectric reflecting layer.

A substrate may be virtually of any thickness as long as it is sufficiently thick to provide material to furnish the grating structure and to resist deformation or fractures due to the stress associated with an intended use. Preferred gratings for use in a line narrowing unit for an excimer laser would have substrate dimensions on the order of about 30 mm×160 mm×30 mm to about 35 mm×300 mm×35 mm. Preferably, the length of the grooves would vary according to or with the grating substrate dimensions (e.g., groove lengths from about 30 to 35 mm). More particularly, a preferred grating substrate would have the dimensions of 30 mm×160 mm×30 mm with a groove length of 30 mm; another preferred grating substrate would have dimensions of about about 35 mm×300 mm×35 mm and a groove length of 35 mm.

The substrate of a preferred diffraction grating according to the present invention is metal, more preferably, aluminum. Other reflective metals and materials (e.g., chromium, magnesium fluoride, silicon and germanium) are also suitable.

A preferred grating has a coating combining an aluminum layer with a MgF₂-layer.

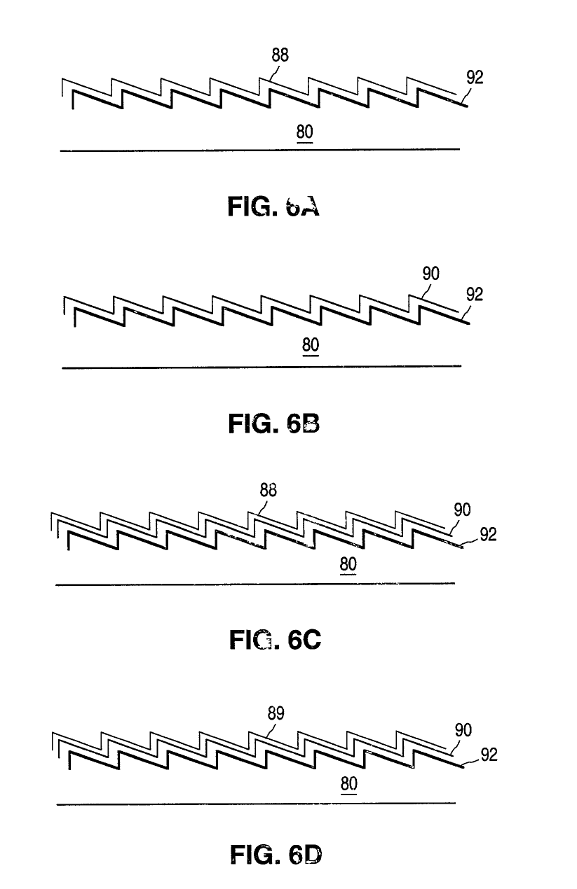

FIGS. 6A-6D show several preferred diffraction gratings. These gratings have a substrate body (80) with a grating structure defined therein. The gratings of FIG. 6 differ from prior art gratings where the grating structure is formed on the surface of a thin epoxy layer placed on the surface of a substrate body made of glass or ceramic material (FIG. 2).

In a preferred embodiment, the substrate body (80) of FIG. 6 is made of metal (e.g., aluminum). In this preferred embodiment, rapid (within <1 second) temperature variations could also be a problem if they are greater than the temperature variation indicated by the above thermal expansion expression. In preferred embodiments, the grating surface (92) is coated by a highly UV reflecting dielectric material (88) (FIG. 6A) or a thin reflective aluminum layer (90) (FIG. 6B) or an aluminum layer coated (90) with a dielectric protecting layer (88) (FIG. 6C) or an aluminum layer (90) with an UV reflection enhancing dielectric coating (89) (FIG. 6D).

This structure is much more stable against heating and aging effects because of the absence of the organic epoxy layer which could be easily affected by heat and UV radiation. A second related advantage of the preferred embodiment made of aluminum is the high thermal conductivity of a grating body made of a metal as compared to one made of glass or ceramic.

Preferred groove distances for diffraction gratings are ascertained according to the above discussed formula. These preferred distances can be readily determined for a particular laser by substituting the wavelength of the laser beam and the incident and reflective angles of the grating. Preferred groove distances correspond to blaze angles in excess of 76° and wavelengths between about 150 nm and 350 nm. More particularly, preferred groove distances correspond to blaze angles between 76° and 82° and wavelengths of about 248 nm, 193 nm, 351 nm, 222 nm, 266 nm, 355 nm, 308 nm, and 157 nm.

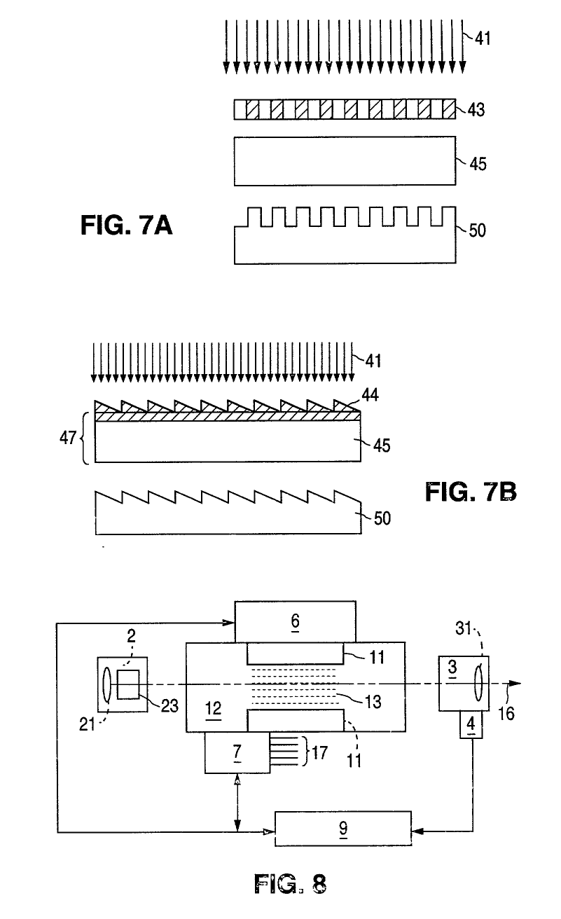

FIG. 7A shows a way for making a preferred diffraction grating (50). An ion beam (41) is used to irradiate the surface of the substrate itself (45) after passing an attenuator (43) providing an attenuation corresponding to a desired grating pattern. If the ion beam cross section is smaller than the substrate surface, the beam may be scanned across the surface.

A special procedure of this ion beam etching is depicted in FIG. 7B. In FIG. 7B, an intermediate diffraction grating replica (47) is first made according to methods available to one of ordinary skill in the art. For instance, a master grating is first formed by etching with a diamond stylus. However, the master grating may be formed by other processes and may even be a replica of another master. The diffraction grating surfaces of the master may then be treated with a release agent, such as silicone, so as to facilitate separation of the replica from the master. The release layer is preferably very thin, only a few nanometers in thickness. Then, a replica is built up on the master using known techniques. See U.S. Pat. No. 5,999,318. In a preferred embodiment, the intermediate replica diffraction grating structure (44) is made of epoxy and the intermediate replica substrate (45) is made of aluminum.

As shown in FIG. 7B, the intermediate replica (47) is then subject to etching by an ion beam (41) which removes the epoxy diffraction grating (44) and forms a diffraction grating (50) according to the invention at the same time. As indicated in FIG. 7B, the ion beams (41) remove both the epoxy (44) and some of the substrate body (45) in order to form the grating (50). As the epoxy (44) covers the substrate body in varying thicknesses, the substrate body (45) is variably etched according to the overlying thickness of the epoxy grating structure (44). As a result, a diffraction grating structure which corresponds to the structure of the intermediate epoxy grating structure is reproduced in the surface of the substrate body (50).

A preferred embodiment of the invention therefore is a narrow line width excimer laser system for use in optical lithography which incorporates a reflective diffraction grating for use in line narrowing. The diffraction grating has a particularly high damage threshold as the diffraction grating is etched directly in the surface material of the substrate which is preferably aluminum.

A preferred embodiment of the invention is an excimer or molecular fluorine laser for generating a laser output bandwidth of less than 0.6 pm, and preferably 0.4 pm or less. The laser resonator preferably includes a laser tube surrounded by a resonator including a line-narrowing unit and an outcoupler. The line-narrowing unit includes a beam expander and a diffraction grating as taught herein, and may include one or more etalons. The diffraction grating is advantageously configured to provide enhanced dispersion for reducing the bandwidth in accord with the above objects and designed to better withstand the intense UV light and heat associated with a laser application and the increased dispersion of laser radiation.

A preferred narrow band laser resonator according to the invention incorporates a diffraction grating having a diffraction grid directly formed in the surface of the substrate. The substrate is preferably aluminum. This grating forms part of a line-narrowing unit providing a Littrow configuration of beam expanding prisms and the diffraction grating. The grating is substituted for the highly reflective mirror of the semi-narrow band laser, described above. The grating is preferably an echelle-type blazed reflection grating having a blaze angle above 76° and, more preferably, between 78° and 82°. Perhaps the most significant factor in the line narrowing is the dispersive power of the grating. Preferably, a plurality of beam expanding prisms are also used to magnify the beam, thus reducing the beam divergence by the same magnification factor, and contributing to the narrowing of the bandwidth. One or more etalons may also be added for further line narrowing, either just before the grating, or between the prisms, or as an outcoupler.

The present invention will be particularly described for use with a KrF-excimer laser emitting around 248 nm, although the present invention may be advantageously used for spectral narrowing of other lasers, especially pulsed gas discharge lasers such as excimer and molecular and molecular flourine lasers emitting in the deep ultraviolet (DUV) or vacuum ultraviolet (VUV). These lasers have particularly become very important for industrial applications such as photolithography. Such lasers generally include a discharge chamber containing two or more gases such as a halogen and one or two rare gases. Examples of such lasers include KrF (248 nm), ArF (193 nm), XeF (350 nm), KrCl (222 nm), XeCl (308 nm), and F₂ (157 nm) lasers. The inventive methods are preferably applied to a wide variety of such gas discharge laser systems.

FIG. 8 schematically illustrates a first laser resonator configuration for an excimer or molecular fluorine laser in accord with the present invention. In this system, there is a gas discharge chamber (12) containing the laser gas mixture, a fan (not shown) and heat exchanger (not shown). Pressure and temperature gauges for monitoring the gas pressure and temperature within the tube may also be provided. The chamber (12) contains a pair of main electrodes (11), the anode and cathode, which define between them a main discharge gas volume (13). It also may contain a preionization unit (not shown). The electrical pulse power and discharge module (6) is connected to the main discharge electrodes (11).

The tube includes resonator units in optic modules at each end: a rear optics module (2) and a front optics module (3). The rear optics module (2) contains a high reflective means (21). Preferred rear high reflective means can be a mirror or reflective grating for line narrowing and additional optical elements for beam steering or forming like mirrors or prisms. A wavelength calibration module (23) is preferably included with the rear optics module (2). Wavelength calibration units or devices and techniques are disclosed in U.S. Pat. No. 4,905,243 and U.S. patent application Ser. Nos. 09/136,275, 09/167,657 and 09/179,262, each of which is assigned to the same assignee as the present application and is hereby incorporated by reference. The diffraction gratings disclosed herein are readily substituted by one of ordinary skill in the art for the diffraction gratings disclosed in each of these references.

The front optic module (3) contains an outcoupling means (31) and optionally additional elements for beam steering and shaping the output beam (16). The front optics module (3) preferably contains an output coupling resonator reflector (31) and optional elements, such as mirrors, beam splitters, prisms or dispersive elements (e.g., gratings, etalons) for beam steering splitting or forming. Such optical elements and techniques are described in U.S. Pat. Nos. 4,399,540, 4,905,243, 5,226,050, 5,559,816, 5,659,419, 5,663,973, 5,761,236, and 5,946,337, and U.S. patent application Ser. Nos. 09/317,695, 09/130,277, 09/244,554, 09/317,527, 09/073,070, Nos. 60/124,241, 60/140,532, 60/140,531, and 60/171,717 each of which is assigned to the same assignee as the present application, and U.S. Pat. Nos. 5,095,492, 5,684,822, 5,835,520, 5,852,627, 5,856,991, 5,898,725, 5,901,163, 5,917,849, 5,970,082, 5,404,366, 4,975,919, 5,142,543, 5,596,596, 5,802,094, 4,856,018, and 4,829,536, which are each hereby incorporated by reference into the present application, as describing line narrowing, selection and/or tuning elements, devices and/or techniques. The high damage threshold diffraction gratings described in detail above are readily substituted by one of ordinary skill in the art for the gratings disclosed in these references. These diffraction gratings are according to structures preferably etched on the surface of a substrate, this substrate is preferably metal, and more preferably, aluminum. The preferred blaze angles are as described above.

In a preferred embodiment, dispersive gratings are employed for spectral narrowing. See, e.g., U.S. Pat. No. 5,095,492 to Sandstrom; and U.S. Pat. No. 4,696,012 to Harshaw. Prisms may also be used as wavelength selection devices. See U.S. Pat. No. 5,761,236. Fabry-Perot etalons may also be employed as wavelength selection devices. See M. Okada and S. Leiri, Electronic Tuning of Dye Lasers by an Electro-Optic Birefringent Fabry-Perot Etalon, Optics Communications, vol. 14, No. 1 (May 1975). Birefringent plates are also used for wavelength selection. See A. Bloom, Modes of a Laser Resonator Containing Tilted Birefringent Plates, Journal of the Optical Society of America, Vol. 64, No. 4 (April 1974); See also U.S. Pat. No. 3,868,592 to Yarborough et al. Unstable resonator configurations may be employed within pulsed excimer lasers. See, e.g., U.S. Pat. No. 5,684,822 to Partlo. U.S. Pat. No. 4,873,692 to Johnson et al. discloses a solid state laser including a rotatable grating and a fixed beam expander for narrowing the linewidth and tuning the wavelength of the laser. Further background information on methods of spectral linewidth narrowing of lasers can be found in textbooks on the tunable lasers. See, e.g., A. E. Siegman, Lasers (1986). Each of the above references of this paragraph is herein incorporated by reference.

An electrical pulse power and discharge unit (6) energizes the laser gas mixture. The pulse power and discharge unit provides energy to the laser gas mixture via a pair of main electrodes (11) within the discharge chamber. An electrical pulse power and discharge unit (6) energizes the laser gas mixture. The pulse power and discharge unit provides energy to the laser gas mixture via a pair of main electrodes (11) within the discharge chamber. Preferably, a preionization element of the pulse power and discharge unit (not shown) is also energized for preionizing the gas just prior to the main discharge. The discharge circuit includes a power supply and pulser circuit for energizing the gas mixture. Preferred circuits (not shown) and circuit components such as main electrodes (11) and preionization electrodes (not shown) are described at U.S. patent application Ser. Nos. 08/842,578, 08/822,451, 09/390,146, 09/247,887, Nos. 60/128,227 and 60/162,645, each of which is assigned to the same assignee as the present application and which is hereby incorporated by reference.

The energy of the output beam (16) has a known dependence on driving voltage of the pulse power module (6). The driving energy is preferably adjusted during laser operation to control and stabilize the energy of the output beam. The processor (9) controls the driving voltage based upon the beam energy information received from the energy monitor (4). Suitable energy monitors include photodetectors, photodiodes, and pyroelectric detectors. Means for regulating laser operation and conditions to control the output beam are described in U.S. patent application No. 60/130,392 and its related non-provisional U.S. patent application Ser. No. 09/550,558 which are assigned to the same assignee and hereby incorporated by reference in their entirety.

The gas mixture of an excimer or molecular fluorine laser is characterized as being strongly electronegative and maintained at an elevated pressure (e.g., a few bars). The gas mixture for an excimer laser includes an active rare gas such as krypton, argon or xenon, a halogen containing species such as fluorine or hydrogen chloride, and a buffer gas such as neon or helium. A molecular fluorine laser includes molecular fluorine and a buffer gas such as neon and/or helium.

The gas mixture is naturally heated as it is excited by the electrical discharge in the discharge area. The heat exchanger (not shown) cools the heated gas after it exits the discharge area. The portion of the gas mixture that participates in a laser pulse is replaced by fresh gas before the next laser pulse occurs. A gas supply unit (7) also typically supplies fresh gas to the system from outside gas containers (17) to replenish each of the components of the gas mixture. In particular, halogen is typically supplied because the halogen concentration in the gas mixture tends to deplete during operation, while it is desired to maintain a constant or near constant halogen concentration in the gas mixture. Means for releasing some of the gas mixture is also typically provided so that the gas pressure can be controlled. Preferred gas replenishment procedures are set forth in U.S. provisional patent application No. 60/124,785 and U.S. provisional patent application No. 60/130,392 and its related non-provisional U.S. patent application Ser. No. 09/550,558 which are assigned to the same assignee and hereby incorporated by reference in their entireties.

Preferred gas mixtures and methods of stabilizing gas mixtures of these excimer lasers and other lasers such as the XeF, XeCl, KrCl excimer lasers, as well as the molecular fluorine laser, and laser tube configurations with respect to the gas flow vessel are described at: U.S. Pat. Nos. 4,393,505, 4,977,573 and 5,396,514, and U.S. patent application Ser. Nos. 09/317,526, 09/418,052, 09/379,034, Nos. 60/160,126, 60/128,227 and 60/124,785, each of which is assigned to the same assignee as the present application, and also U.S. Pat. Nos. 5,440,578 and 5,450,436, all of the above U.S. patents and patent applications being hereby incorporated by reference into the present application. Gas purification systems, such as cryogenic gas filters (see U.S. Pat. Nos. 4,534,034, 5,136,605, 5,430,752, 5,111,473 and 5,001,721 assigned to the same assignee, and hereby incorporated by reference) or electrostatic particle filters (see U.S. Pat. No. 4,534,034, assigned to the same assignee and U.S. Pat. No. 5,586,134, each of which is incorporated by reference) may also be used to extend excimer laser gas lifetimes.

In the laser system of FIG. 8, a processor preferably (9) receives signals from both the energy monitor (4) and the power supply unit. The laser system of FIG. 8 accommodates still additional signals indicative of the laser operational status from other devices (not shown) monitoring discharge chamber gas status (e.g., discharge chamber gas temperature and pressure gauges, discharge chamber gas composition monitors) and devices measuring other laser operational status parameters such as a driving voltage meter. These additional signals would also be received by the processor (9).

In the systems according to FIG. 8, the processor (9) preferably applies algorithms to generate its control signals based upon input signals from the energy monitor (4) and any other system status monitors. These algorithms may utilize reference values for the monitor signals and information based upon the history of past gas actions signals to generate control signals. These control signals are received by the gas supply unit (7) which regulates the flow of replenishment gases into the discharge chamber (12) and any release of the discharge chamber gas mixture according to the control signal from the processor (9).

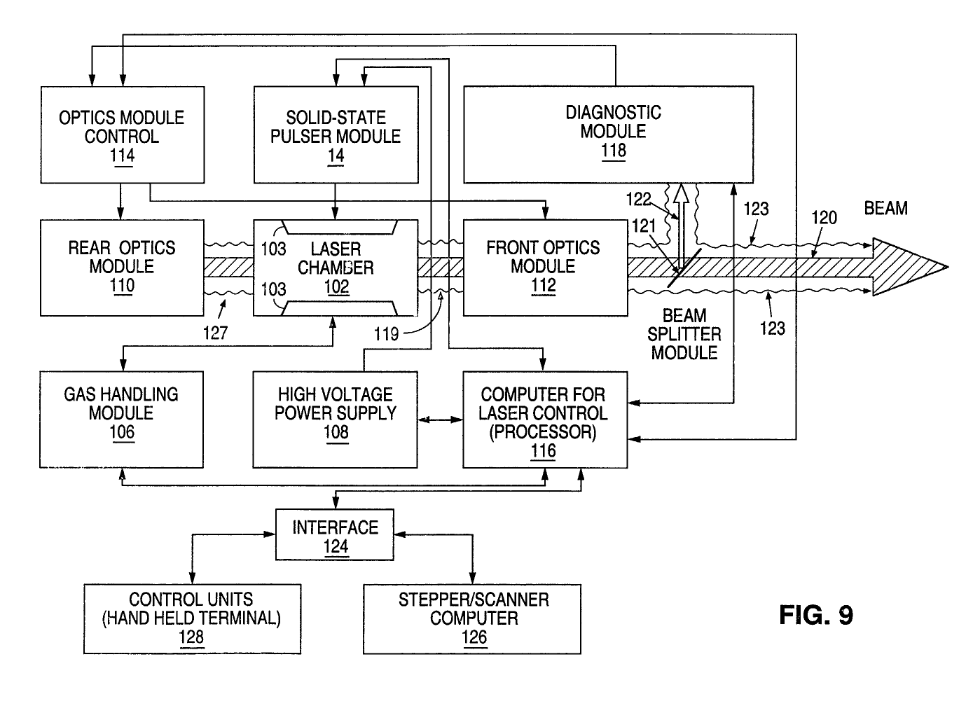

Referring to FIG. 9, an excimer or molecular fluorine laser system for deep ultraviolet (DUV) or vacuum ultraviolet (VUV) lithography, respectively, is schematically shown. Alternative configurations for laser systems for use in such other industrial applications as TFT annealing and/or micromachining, e.g., are understood by one skilled in the art as being similar to and/or modified from the system shown in FIG. 9 to meet the requirements of that application. For this purpose, alternative DUV/VUV laser system and component configurations are described at U.S. patent application Ser. Nos. 09/317,695, 09/317,526, 09/317,527, 09/343,333, Nos. 60/122,145, 60/140,531, 60/162,735, 60/166,952, 60/171,172, 60/141,678, 60/173,993, 60/166,967,60/172,674, and 60/181,156, and U.S. patent application of Kleinschmidt, serial number not yet assigned, filed May 18, 2000, for “Reduction of Laser Speckle in Photolithography by Controlled Disruption of Spatial Coherence of Laser Beam,” and U.S. Pat. No. 6,005,880, each of which is assigned to the same assignee as the present application and is hereby incorporated by reference.

The system shown in FIG. 9 generally includes a laser chamber 102 having a pair or several pairs of main discharge electrodes 103 and one or more preionization electrodes connected with a solid-state pulser module 104, and a gas handling module 106. The solid-state pulser module 104 is powered by a high voltage power supply 108. The laser chamber 102 is surrounded by optics module 110 and optics module 112, forming a resonator. The optics modules 110 and 112 are controlled by an optics control module 114.

A computer 116 for laser control receives various inputs and controls various operating parameters of the system. A diagnostic module 118 receives and measures various parameters of a split off portion of the main beam 120 via optics for deflecting a small portion of the beam toward the module 118, such as preferably a beam splitter module 121, as shown. The beam 120 is preferably the laser output to an imaging system (not shown) and ultimately to a workpiece (also not shown). The laser control computer 116 communicates through an interface 124 with a stepper/scanner computer 126 and other control units 128.

The laser chamber 102 contains a laser gas mixture and includes a pair of or several pairs of main discharge electrodes 103 and one or more preionization electrodes (not shown). Preferred main electrodes 103 are described at U.S. patent application Ser. No. 09/453,670, Nos. 60/184,705 and 60/128,227, each of which is assigned to the same assignee as the present application and is hereby incorporated by reference. Other electrode configurations are set forth at U.S. Pat. Nos. 5,729,565 and 4,860,300, each of which is assigned to the same assignee, and alternative embodiments are set forth at U.S. Pat. Nos. 4,691,322, 5,535,233 and 5,557,629, all of which are hereby incorporated by reference. The laser chamber 102 also includes a preionization arrangement (not shown). Preferred preionization units are set forth at U.S. patent application Nos. 60,162,845, 60/160,182, 60/127,237, Ser. Nos. 09/535,276 and 09/247,887, each of which is assigned to the same assignee as the present application, and alternative embodiments are set forth at U.S. Pat. Nos. 5,337,330, 5,818,865 and 5,991,324, all of the above patents and patent applications being hereby incorporated by reference.

The solid-state pulser module 114 and high voltage power supply 108 supply electrical energy in compressed electrical pulses to the preionization and main electrodes 103 within the laser chamber 102 to energize the gas mixture. The preferred pulser module and high voltage power supply are described at U.S. patent application Nos. 60/149,392, 60/198,058, and Ser. No. 09/390,146, and U.S. patent application of Osmanow, et al., serial number not yet assigned, filed May 15, 2000, for “Electrical Excitation Circuit for Pulsed Laser”, and U.S. Pat. Nos. 6,005,880 and 6,020,723, each of which is assigned to the same assignee as the present application and which is hereby incorporated by reference into the present application. Other alternative pulser modules are described at U.S. Pat. Nos. 5,982,800, 5,982,795, 5,940,421, 5,914,974, 5,949,806, 5,936,988, 6,028,872 and 5,729,562, each of which is hereby incorporated by reference. A conventional pulser module may generate electrical pulses in excess of 3 Joules of electrical power (see the '988 patent, mentioned above).

The laser resonator which surrounds the laser chamber 102 containing the laser gas mixture includes optics module 110 including line-narrowing optics for a line narrowed excimer or molecular fluorine laser, which may be replaced by a high reflectivity mirror or the like in a laser system wherein either line-narrowing is not desired, or if line narrowing is performed at the front optics module 112, or an spectral filter external to the resonator is used for narrowing the linewidth of the output beam. Several variations of line-narrowing optics are set forth in detail below.

The laser chamber 102 is sealed by windows transparent to the wavelengths of the emitted laser radiation 114. The windows may be Brewster windows or may be aligned at another angle to the optical path of the resonating beam. The beam path between the laser chamber and each of the optics modules 110 and 112 is sealed by enclosures 117 and 119, and the interiors of the enclosures is substantially free of water vapor, oxygen, hydrocarbons, fluorocarbons and the like which otherwise strongly absorb VUV laser radiation.

After a portion of the output beam 120 passes the outcoupler of the optics module 112, that output portion impinges upon beam splitter module 121 which includes optics for deflecting a portion of the beam to the diagnostic module 118, or otherwise allowing a small portion of the outcoupled beam to reach the diagnostic module 118, while a main beam portion 120 is allowed to continue as the output beam 120 of the laser system. Preferred optics include a beamsplitter or otherwise partially reflecting surface optic. The optics may also include a mirror or beam splitter as a second reflecting optic. More than one beam splitter and/or HR mirror(s), and/or dichroic mirror(s) may be used to direct portions of the beam to components of the diagnostic module 118. A holographic beam sampler, transmission grating, partially transmissive reflection diffraction grating, grism, prism or other refractive, dispersive and/or transmissive optic or optics may also be used to separate a small beam portion 122 from the main beam 120 for detection at the diagnostic module 118, while allowing most of the main beam 120 to reach an application process directly or via an imaging system or otherwise. The output beam 120 may be transmitted at the beam splitter module while a reflected beam portion 122 is directed at the diagnostic module 118, or the main beam 120 may be reflected, while a small portion 122 is transmitted to the diagnostic module 118. The portion of the outcoupled beam which continues past the beam splitter module 121 is the output beam 120 of the laser, which propagates toward an industrial or experimental application such as an imaging system and workpiece for photolithographic applications.

An enclosure 123 seals the beam path of the beams 122 and 120 such as to keep the beam paths free of photoabsorbing species. Smaller enclosures 117 and 119 seal the beam path between the chamber 102 and the optics modules 110 and 112. The preferred enclosure 123 and beam splitting module 121 are described in detail in the Ser. No. 09/343,333 and No. 60/140,530 applications, incorporated by reference above, and in U.S. patent application Ser. No. 09/131,580, which is assigned to the same assignee and U.S. Pat. Nos. 5,559,584, 5,221,823, 5,763,855, 5,811,753 and 4,616,908, all of which are hereby incorporated by reference. For example, the beam splitting module 121 preferably also includes optics for filtering visible red light from the beam 122 so that substantially only VUV light is received at a detector of the diagnostic module 118. Filtering optics may also be included for filtering red light from the output beam 120. Also, an inert gas purge is preferably flowing through the enclosure 123.

The diagnostic module 118 preferably includes at least one energy detector. This detector measures the total energy of the beam portion that corresponds directly to the energy of the output beam 120. An optical configuration such as an optical attenuator, e.g., a plate or a coating, or other optics may be formed on or near the detector or beam splitter module 121 to control the intensity, spectral distribution and/or other parameters of the radiation impinging upon the detector (see U.S. patent application Ser. No. 09/172,805, Nos. 60/172,749, 60/166,952 and 60/178,620, each of which is assigned to the same assignee as the present application and is hereby incorporated by reference).

One other component of the diagnostic module 118 is preferably a wavelength and/or bandwidth detection component such as a monitor etalon or grating spectrometer (see U.S. patent application Ser. No. 09/416,344, Nos. 60/186,003, 60/158,808, and 60/186,096, and Lokai, et al., serial number not yet assigned, “Absolute Wavelength Calibration of Lithography Laser Using Multiple Element or Tandem See Through Hollow Cathode Lamp”, filed May 10, 2000, each of which is assigned to the same assignee as the present application, and U.S. Pat. Nos. 4,905,243, 5,978,391, 5,450,207, 4,926,428, 5,748,346, 5,025,445, and 5,978,394, all of the above wavelength and/or bandwidth detection and monitoring components being hereby incorporated by reference.

Other components of the diagnostic module may include a pulse shape detector or ASE detector, such as are described at U.S. patent application Ser. Nos. 09/484,818 and 09/418,052, respectively, each of which is assigned to the same assignee as the present application and is hereby incorporated by reference, such as for gas control and/or output beam energy stabilization. There may be a beam alignment monitor, e.g., such as is described at U.S. Pat. No. 6,014,206 which is hereby incorporated by reference.

The processor or control computer 116 receives and processes values of some of the pulse shape, energy, amplified spontaneous emission (ASE), energy stability, energy overshoot for burst mode operation, wavelength, spectral purity and/or bandwidth, among other input or output parameters of the laser system and output beam. The processor 116 also controls the line narrowing module to tune the wavelength and/or bandwidth or spectral purity, and controls the power supply and pulser module 104 and 108 to control preferably the moving average pulse power or energy, such that the energy dose at points on the workpiece is stabilized around a desired value. In addition, the computer 116 controls the gas handling module 106 which includes gas supply valves connected to various gas sources.

The laser gas mixture is initially filled into the laser chamber 102 during new fills. The gas composition for a very stable excimer laser in accord with the preferred embodiment uses helium or neon or a mixture of helium and neon as buffer gas, depending on the laser. Preferred gas composition are described at U.S. Pat. Nos. 4,393,405 and 4,977,573 and U.S. patent application Ser. Nos. 09/317,526, 09/513,025, No. 60/124,785, Ser. No. 09/418,052, Nos. 60/159,525 and 60/160,126, each of which is assigned to the same assignee and is hereby incorporated by reference into the present application. The concentration of the fluorine in the gas mixture may range from 0.003% to 1.00%, and is preferably around 0.1%. An additional gas additive, such as a rare gas, may be added for increased energy stability and/or as an attenuator as described in the '025 application, mentioned above. Specifically, for the F2-laser, an addition of Xenon and/or Argon may be used. The concentration of xenon or argon in the mixture may range from 0.0001% to 0.1%. For an ArF-laser, an addition of xenon or krypton may be used also having a concentration between 0.0001% to 0.1%.

Halogen and rare gas injections, total pressure adjustments and gas replacement procedures are performed using the gas handling module 106 preferably including a vacuum pump, a valve network and one or more gas compartments. The gas handling module 106 receives gas via gas lines connected to gas containers, tanks, canisters and/or bottles. Preferred gas handling and/or replenishment procedures of the preferred embodiment, other than as specifically described herein, are described at U.S. Pat. Nos. 4,977,573 and 5,396,514 and U.S. patent application No. 60/124,785, Ser. Nos. 09/418,052, 09/379,034, Nos. 60/171,717, and 60/159,525, each of which is assigned to the same assignee as the present application, and U.S. Pat. Nos. 5,978,406, 6,014,398 and 6,028,880, all of which are hereby incorporated by reference. A Xe gas supply may be included either internal or external to the laser system according to the '025 application, mentioned above.

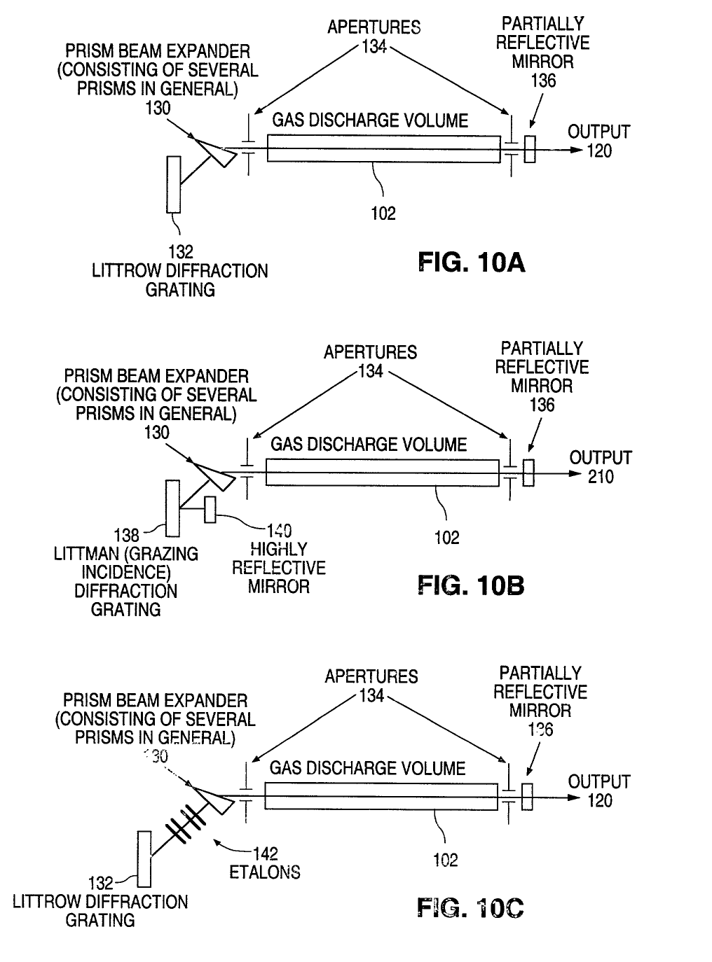

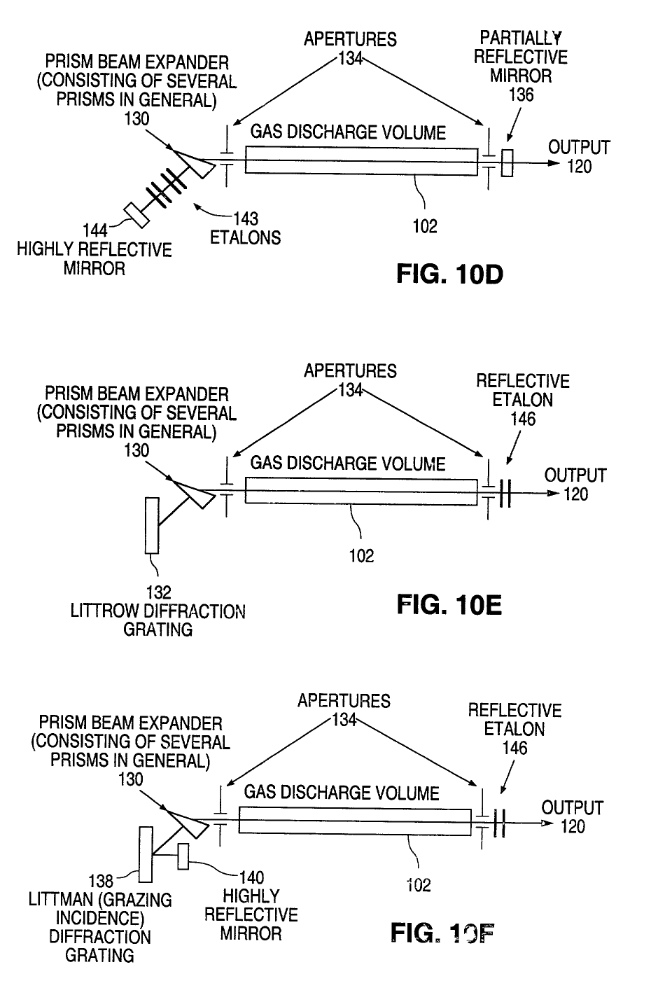

A general description of the line-narrowing features of the several embodiments of the present is first provided here, followed by a detailed discussion referring FIGS. 10a-14b. Exemplary line-narrowing optics are contained in the optics module 110 include a beam expander, an optional etalon and a diffraction grating, which produces a relatively high degree of dispersion, for a narrow band laser such as is used with a refractive or catadioptric optical lithography imaging system. As mentioned above, the front optics module may include line-narrowing optics as well (see the Nos. 60/166,277, 60/173,993 and 60/166,967 applications, each being assigned to the same assignee and hereby incorporated by reference). For a semi-narrow band laser such as is used with an all-reflective imaging system, and which is not the subject of the present invention, the grating is replaced with a highly reflective mirror, and a lower degree of dispersion may be produced by a dispersive prism. A semi-narrow band laser would typically have an output beam linewidth in excess of 1 pm and may be as high as 100 pm in some laser systems, depending on the characteristic free-running bandwidth of the laser.

The beam expander of the above exemplary line-narrowing optics of the optics module 110 preferably includes one or more prisms. The beam expander may include other beam expanding optics such as a lens assembly or a converging/diverging lens pair. The grating or highly reflective mirror is preferably rotatable so that the wavelengths reflected into the acceptance angle of the resonator can be selected or tuned. Alternatively, the grating, or other optic or optics, or the entire line-narrowing module may be pressure tuned, such as it set forth in the No. 60/178,445 and Ser. No. 09/317,527 applications, each of which is assigned to the same assignee and is hereby incorporated by reference. The grating may be used both for dispersing the beam for achieving narrow bandwidths and also preferably for retroreflecting the beam back toward the laser tube. Alternatively, a highly reflective mirror is positioned after the grating which receives a reflection from the grating and reflects the beam back toward the grating to doubly disperse the beam, or the grating may be a transmission grating. One or more dispersive prisms may also be used, and more than one etalon may be used.

Depending on the type and extent of line-narrowing and/or selection and tuning that is desired, and the particular laser that the line-narrowing optics are to be installed into, there are many alternative optical configurations that may be used. For this purpose, those shown in U.S. Pat. Nos. 4,399,540, 4,905,243, 5,226,050, 5,559,816, 5,659,419, 5,663,973, 5,761,236, and 5,946,337, and U.S. patent application Ser. Nos. 09/317,695, 09/130,277, 09/244,554, 09/317,527, 09/073,070, Nos. 60/124,241, 60/140,532, 60/147,219 and 60/140,531, 60/147,219, 60/170,342, 60/172,749, 60/178,620, 60/173,993, 60/166,277, 60/166,967, 60/167,835, 60/170,919, 60/186,096, each of which is assigned to the same assignee as the present application, and U.S. Pat. Nos. 5,095,492, 5,684,822, 5,835,520, 5,852,627, 5,856,991, 5,898,725, 5,901,163, 5,917,849, 5,970,082, 5,404,366, 4,975,919, 5,142,543, 5,596,596, 5,802,094, 4,856,018, 5,970,082, 5,978,409, 5,999,318, 5,150,370 and 4,829,536, and German patent DE 298 22 090.3, are each hereby incorporated by reference into the present application.

Optics module 112 preferably includes means for outcoupling the beam 120, such as a partially reflective resonator reflector. The beam 120 may be otherwise outcoupled such as by an intraresonator beam splitter or partially reflecting surface of another optical element, and the optics module 112 would in this case include a highly reflective mirror. The optics control module 114 controls the optics modules 110 and 112 such as by receiving and interpreting signals from the processor 116, and initiating realignment or reconfiguration procedures (see the '241, '695, 277, 554, and 527 applications mentioned above).

A detailed discussion of the line-narrowing configurations of an oscillator element of the laser system according to the preferred embodiment is now set forth with reference to FIGS. 10a-10f. Several embodiments of an oscillator of the laser system using line-narrowing techniques for the molecular fluorine laser, are shown in FIGS. 10a-10f to meet or substantially meet the first object of the invention.

FIG. 10a schematically shows an oscillator of a laser system according to a first embodiment including a discharge chamber 102 preferably containing molecular fluorine and a buffer gas of neon, helium or a combination thereof (see the Ser. No. 09/317,526 application), and having a pair of main discharge electrodes 103 (not shown) and a preionization arrangement (also not shown) therein. The system shown in FIG. 2a also includes a prism beam expander 130 and a diffraction grating 132 arranged in a Littrow configuration. The beam expander 130 may include one or more prisms and preferably includes several prisms. The beam expander serves to reduce divergence of the beam incident onto the grating, thus improving wavelength resolution of the wavelength selector. The grating is preferably a high blaze angle echelle grating (see the No. 60/170,342 application incorporated by reference above).

The system shown includes a pair of apertures 134 in the resonator which reject stray light and reduce broadband background, and can also serve to reduce the linewidth of the beam by lowering the acceptance angle of the resonator. Alternatively, one aperture 134 on either side of the chamber 102 may be included, or no apertures 134 may be included. Exemplary apertures 134 are set forth at U.S. Pat. No. 5,161,238, which is assigned to the same assignee and is hereby incorporated by reference (see also the Ser. No. 09/130,277 application incorporated by reference above).

The system of FIG. 10a also includes a partially reflecting output coupling mirror 136. The outcoupling mirror 136 may be replaced with a highly reflective mirror, and the beam may be otherwise output coupled such as by using a polarization reflector or other optical surface within the resonator such as a surface of a prism, window or beam-splitter (see, e.g., U.S. Pat. No. 5,150,370, incorporated by reference above).

The system shown at FIG. 10b includes the chamber 102, the apertures 134, the partially reflecting output coupling mirror 136 and beam expander 130 described above with respect to FIG. 10a. The system of FIG. 10b also includes a diffraction grating 138 and a highly reflective mirror 140. The grating 138 preferably differs from the grating 132 of FIG. 10a either in its orientation with respect to the beam, or its configuration such as its blaze angle, etc., or both. The laser beam is incident onto the grating 138 at an angle closer to 90° than for the grating 132. The incidence angle is, in fact, preferably very close to 90°. This is arrangement is referred to here as the Littman configuration. The Littman configuration increases the wavelength dispersion of the grating 138. After passing through or reflecting from the diffraction grating 138, the diffracted beam is reflected by the highly reflective mirror 140. The tuning of the wavelength is preferably achieved by tilting the highly reflective mirror 140. As mentioned above with respect to the exemplary arrangement, tuning may be achieved otherwise by rotating another optic or by pressure tuning one or more optics, or otherwise as may be understood by one skilled in the art.

FIG. 10c schematically shows another embodiment of an oscillator having a laser chamber 102, apertures 134, outcoupler 136, beam expander 130 and Littrow diffraction grating 132, preferably as described above. In addition, the system of FIG. 2c includes one or more etalons 142, e.g, two etalons are shown, which provide high-resolution line narrowing, while the grating 132 serves to select a single interference order of the etalons 142. The etalon or etalons 142 may be placed in various positions in the resonator, i.e., other than as shown. For example, a prism or prisms of the beam expander 130 may be positioned between an etalon or etalons 142 and the grating. An etalon 142 may be used as an output coupler, as will be described in more detail below with reference to FIGS. 10e-10f. The arrangement of FIG. 10c (as well as FIG. 10d below) including an etalon or etalons 142 may be varied as described at any of U.S. patent application Nos. 60/162,735, 60/178,445, or 60/158,808, each of which is assigned to the same assignee and is hereby incorporated by reference.

FIG. 10d shows another embodiment of the laser system having one or more etalons 143, e.g., two etalons 143 are shown. The system of FIG. 10d is the same as that of FIG. 10c except that the grating 132 is replaced with a highly reflective mirror, and the etalons 143 are differently configured owing to the omission of the grating 132 which is not available, as in the system of FIG. 10c, to select a single interference order of the etalons 143. The free spectral ranges of etalons 143 are instead adjusted in such a way that one of the etalons 143, preferably the first etalon 143 after the beam expander 130, selects a single order of the other etalon 143, e.g., the second etalon 143. The second etalon 143 of the preferred arrangement is, therefore, allowed to have a smaller free spectral range and higher wavelength resolution. Some further alternative variations of the etalons 143 of the system of FIG. 10d may be used as set forth in U.S. Pat. No. 4,856,018, which is hereby incorporated by reference.

FIGS. 10e and 10f schematically show embodiments similar to the arrangements described above with reference to FIGS. 10a and 10b, respectively, which differ in that the partially reflecting outcoupler mirror 136 is replaced with a reflective etalon outcoupler 146. The etalon outcoupler 146 is used in combination with the grating 132 or 138 and beam expander 130 of FIGS. 10e and 10f, respectively, wherein the grating 132 or 138 selects a single interference order of the etalon outcoupler 146. Alternatively, one or more dispersive prisms or another etalon may be used in combination with the etalon outcoupler 146 for selecting a single interference order of the etalon 146. The grating 132 or 138 restricts wavelength range to a single interference order of the outcoupler etalon 146. Variations of the systems of FIGS. 10e and 10f that may be used in combination with the systems set forth at FIG. 10e and/or 10f are set forth at the Ser. No. 09/317,527 and No. 60/166,277 applications, incorporated by reference above, and U.S. Pat. Nos. 6,028,879, 3,609,586, 3,471,800, 3,546,622, 5,901,163, 5,856,991, 5,440,574, and 5,479,431, and H. Lengfellner, Generation of tunable pulsed microwave radiation by nonlinear interaction of Nd:YAG laser radiation in GaP crystals, Optics Letters, Vol. 12, No. 3 (March 1987), S. Marcus, Cavity dumping and coupling modulation of an etalon-coupled CO₂ laser, J. Appl. Phys., Vol. 53, No. 9 (September 1982), and The physics and technology of laser resonators, eds. D. R. Hall and P. E. Jackson, at p. 244, each of which is hereby incorporated by reference.

In all of the above embodiments shown and described with reference to FIGS. 10a-10f, the material used for the prisms of the beam expanders 130, etalons 142, 143, 146 and laser windows is preferably one that is highly transparent at wavelengths below 200 nm, such as at the 157 nm output emission wavelength of the molecular fluorine laser. The materials are also capable of withstanding long-term exposure to ultraviolet light with minimal degradation effects. Examples of such materials are CaF₂, MgF₂, BaF, BaF₂, LiF, LiF₂, and SrF₂. Also, in all of the above embodiments of FIGS. 2a-2f, many optical surfaces, particularly those of the prisms, preferably have an anti-reflective coating on one or more optical surfaces, in order to minimize reflection losses and prolong their lifetime.

Also, as mentioned in the general description above, the gas composition for the F₂ laser in the above configurations uses either helium, neon, or a mixture of helium and neon as a buffer gas. The concentration of fluorine in the buffer gas preferably ranges from 0.003% to around 1.0%, and is preferably around 0.1%. The addition of a trace amount of xenon, and/or argon, and/or oxygen, and/or krypton and/or other gases may be used for increasing the energy stability, burst control, or output energy of the laser beam. The concentration of xenon, argon, oxygen, or krypton in the mixture may range from 0.0001% to 0.1%. Some alternative gas configurations including trace gas additives are set forth at U.S. patent application Ser. Nos. 09/513,025 and 09/317,526, each of which is assigned to the same assignee and is hereby incorporated by reference.

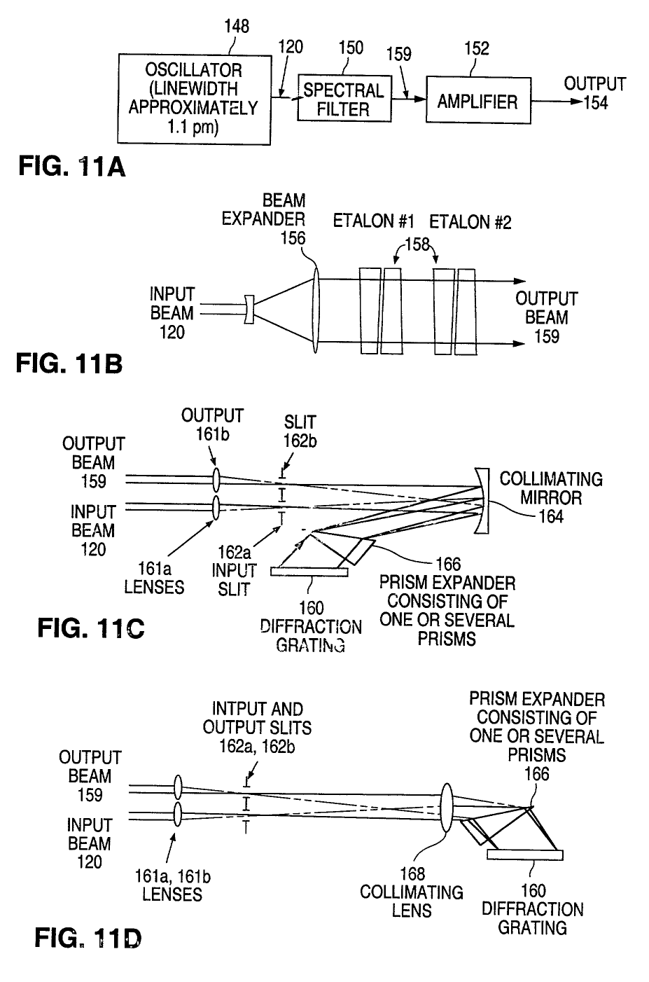

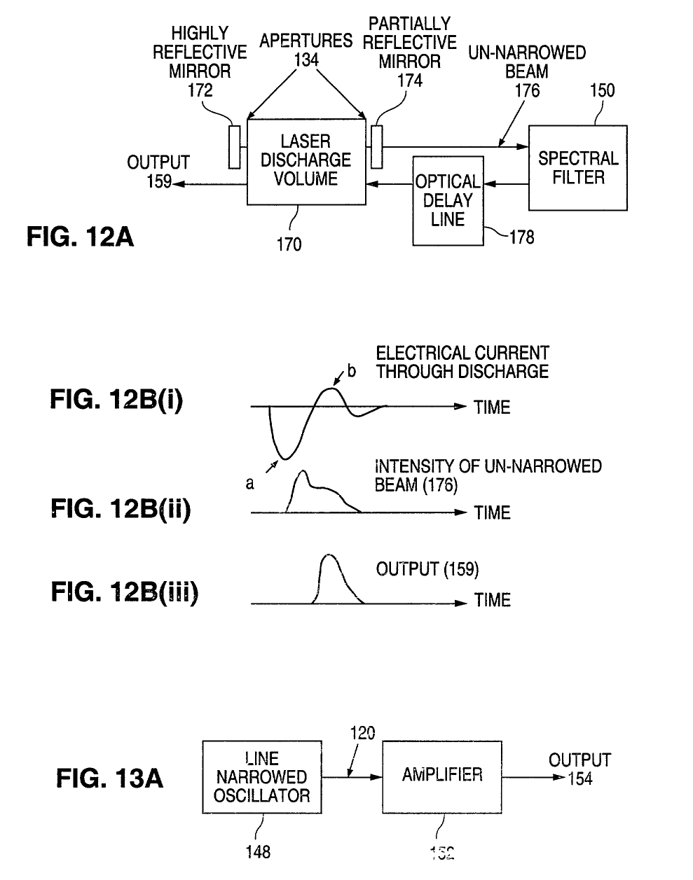

All of the oscillator configurations shown above at FIGS. 10a-10f may be advantageously used to produce a VUV/DUV beam 120 having a wavelength of around 157 nm, 193 nm, 248 nm, etc., and a linewidth of around 1 pm or less and preferably less than 0.6 pm. Some of those configurations having an output linewidth of less than 1 pm already meet the above first object of the invention with respect to the linewidth. Those oscillators may be used with other elements, such as an amplifier, as set forth below at FIGS. 11a-14b to meet the second object of the invention, i.e., to achieve sufficient output power for substantial throughput at a 157 nm lithography fab. Other oscillators producing linewidths above 1 pm may be advantageously used in combination with other line-narrowing elements such as a spectral filter, as set forth below at FIGS. 11a-12b, to meet that first object, and with an amplifier as set forth in the embodiments of FIGS. 11a-12b to meet the second object.

FIG. 11a schematically illustrates, in block form, a laser system in accord with a preferred embodiment of the present invention, wherein a narrower linewidth is desired than is output by the oscillator 148, and higher power is desired than is output by the oscillator 148. To reduce the linewidth, the output beam 120 of the oscillator 148 is directed through a spectral filter 150. To increase the output power, the beam 120 is directed through an amplifier 152.

The system of FIG. 11a includes a line-narrowed oscillator 148, a spectral filter 150 and an amplifier 152. Various preferred configurations of the spectral filter 150 are described below with reference to FIGS. 11b-11d. The oscillator 148 of FIG. 11a is an electrical discharge molecular fluorine laser producing a spectral linewidth of approximately 1 pm, and is preferably one of the configurations described above with respect to FIGS. 10a-10f, or a variation thereof as described above, or as may be understood as being advantageous to one skilled in the art, such as may be found in one or more of the reference incorporated by reference above. The oscillator 148 is followed by the spectral filter 150, which transmits light in a narrower spectral range, i.e., less than the linewidth of the output beam 120 from the oscillator or less than around 1 pm. Lastly, the transmitted beam is amplified in an amplifier 152 based on a separate discharge chamber to yield an output beam 154 that meets both the first and second objects of the invention. Preferably, the oscillator and amplifier discharges are synchronized using a delay circuit and advantageous solid-state pulser circuit such as is described at U.S. patent application No. 60/204,095 and at U.S. Pat. No. 6,005,880, each of which is assigned to the same assignee and is hereby incorporated by reference.

The spectral filter 150 is preferably includes one of the arrangements shown in FIGS. 11b-11d. Variations may be understood as advantageous to one skilled in the art using any of a large number of combinations of prisms, gratings, grisms, holographic beam samplers, etalons, lenses, apertures, beam expanders, collimating optics, etc., for narrowing the linewidth of the input beam 120, preferably without consuming a substantial fraction of the energy of the input beam 120.

FIG. 11b illustrates a first spectral filter 150 embodiment including a beam expander followed by one or more etalons 158 to yield an output beam having a linewidth substantially below the linewidth, e.g., around 1 pm, of the input beam 120 to meet the first object of the invention. Each etalon 158 includes two partially reflecting surfaces of reflectivity R, separated by a preferably gas-filled gap of thickness D. The transmission spectrum of the etalon T(λ) is described by a periodic function of the wavelength λ:

T(λ)=(1+(4F²/π²)sin(2πnD cos(Θ)/λ))⁻¹ (1)

where n is the refractive index of the material, preferably an inert gas, filling the etalon 158, Θ is the tilt angle of the etalon 158 with respect to the beam, and F is the finesse of the etalon 158 which is defined as:

F=πR^{1/2}/(1−R) (2)

The reflectivity R and spacing of the etalon D can be selected in such a way that only a single transmission maximum overlaps with the emission spectrum of the broader-band oscillator 148. For instance, if the finesse of the etalon 158 is selected to be 10, then the spectral width of the transmission maximum is roughly 1/10 of the free spectral range (FSR) of the etalon 158. Therefore, selecting a free spectral range of 1 pm will produce a transmitted beam with spectral linewidth of 0.1 pm, without sidebands since the linewidth of the oscillator (148) output (approximately 1 pm) is significantly less than two times the FSR.

Using multiple etalons 158 allows a higher contrast ratio, which is defined as a ratio of the maximum transmission to the transmission of the wavelength halfway between the maxima. This contrast ratio for a single etalon is approximately equal to (1+4F²/π²). Higher finesse values lead to higher contrast. For several etalons 158, the total contrast ratio will be (1+4F²/π²)ⁿ where n is the number of etalons 158 used. Additionally, the spectral width of the transmission maxima will be reduced with increased number of etalons 158 used. Disadvantages of using several etalons 158 include high cost and complexity of the apparatus and increased optical losses.

The beam expander 156 shown at FIG. 11b serves to reduce the divergence of the beam incident onto the etalons 158. From the formula (1), it follows that a change in the beam incidence angle Θ causes a shift of the wavelength at which maximum transmission occurs. Assuming an FSR of 1 pm, the etalon spacing is D=1.2 cm. If the transmission interference spectrum of the etalon 158 is at its maximum at normal incidence (Θ=0), then the angle Θ, at which the transmission spectrum reaches maximum again is Θ˜(λ/nD)^{1/2}=3.6 mrad. Therefore, it is preferred that the spectral filter 150 shown at FIG. 3b be configured such that the divergence of the beam is below Θ, and preferably by a factor comparable to the finesse F of the etalon 158. Since the divergence of a typical molecular fluorine laser is several millirads, the advantage of using the beam expander 156 to reduce this divergence from typically above Θ as it is output from the oscillator 148 to below Θ, is may be understood. It is also preferred to use one or more apertures 134 in the oscillator 148 to reduce its output divergence (see the Ser. No. 09/130,277 application, mentioned above).

The gaps between the plates of the etalons 158 are preferably filled with an inert gas. Tuning of the transmitted wavelength can be accomplished by changing the pressure of the gas as described in the Ser. No. 09/317,527 application, mentioned above. In addition to pressure tuning and rotation tuning of the etalon's output transmission spectrum, the etalons 158 may be piezoelectrically tuned such as to geometrically alter the gap spacing.

FIG. 11c schematically illustrates a second embodiment of the spectral filter 150 of FIG. 3a generally utilizing a diffraction grating 160. Although there are other ways to configure the spectral filter 150 according to the second embodiment using a grating 160, an example is shown at FIG. 11c and described here. The spectral filter 150 shown at FIG. 11c is a Czerny-Turner type spectrometer, modified to achieve high resolution. The input beam 120 in focused by a lens 161a through an input slit 162a after which the beam is incident on a collimating mirror 164. After reflection from the mirror 164, the beam is incident on a beam expander 166 and then onto the grating 160. The beam is dispersed and reflected from the grating 160, after which the beam retraverses the beam expander 166, and is reflected from the collimating mirror 164 through an output slit 162b at or near the focal point of a lens 162b. The output beam 159 then has a linewidth substantially less than the linewidth, e.g., around 1 pm, of the input beam 120, or substantially less than 1 pm to meet the first object of the invention.

The diffraction grating 160 is preferably a high blaze echelle grating 160. The wavelength dispersion of this preferred grating 160 is described by the following formula:

dλ/dΘ=(2/λ)tan Θ (3)

where Θ is the incidence angle. The spectral width Δλ of the transmitted beam is determined by the dispersion dλ/dΘ of the grating 160, the magnification factor M of the prism expander 166, the focal length L of the collimating mirror 164 and the width d of the slits 162a, 162b of the spectrometer:

Δλ=d(LMdλ/dΘ)⁻¹ (4)

For example, using an echelle grating 160 wherein the incidence angle Θ is 78.6°, L=2 m and M=8, the slit width d which would achieve 0.1 pm resolution for the spectral filter 150 of FIG. 3c is around d=0.1 mm. It is preferred, therefore, to reduce the divergence of the oscillator 148 in order to increase the transmission of the beam 120 through the input slit 161a. This can be advantageously achieved by using apertures inside the resonator of the oscillator 148 (see again the Ser. No. 09/130,277 application, mentioned above).

The third example of a spectral filter 150 that may be used in illustrated at FIG. 11d. The spectral filter 150 of FIG. 11d differs from that shown at FIG. 11c in that a collimating lens 168 is used in the embodiment of FIG. 11d, rather than a collimating mirror 164, as is used in the embodiment of FIG. 11c. An advantage of the embodiment of FIG. 11d is its simplicity and the absence of astigmatism introduced by the mirror 164 of FIG. 11c at non-zero incidence angle.

It is useful to reiterate here that synchronization of the electrical discharge pulses in the chambers 102 of the oscillator 148 and amplifier 152 is preferred in order to ensure that the line-narrowed optical pulse from the oscillator 148 arrives at the chamber 102 of the amplifier 152 at the instance when the gain of the amplifier 152 is at or near its maximum. Additionally, this preferred synchronization timing should be reproducible from pulse to pulse to provide high energy stability of the output pulses. The preferred embodiment electronic circuitry allowing this precise timing control is described at U.S. Pat. No. 6,005,880 and U.S. patent application No. 60/204,095, as mentioned above.

FIG. 12a shows the use of a single discharge chamber 170 that provides the gain medium for both an oscillator and an amplifier. The setup of FIG. 12a includes the discharge chamber 170 within a resonator including a highly reflective mirror 172 and a partially reflecting outcoupling mirror 174. A pair of apertures 134 are also included, as described above, to match the divergence of the resonator of this oscillator 148. A small portion of the cross-section of the discharge volume is used to produce an un-narrowed beam 176 with this oscillator configuration. It is also possible to include one or more line-narrowing components with this oscillator configuration, or to otherwise modify the oscillator according to the description set forth above with respect to FIGS. 10a-10f.

Similar to the embodiment shown and described with respect to FIG. 11a, this un-narrowed output is then directed through a spectral filter 150, which is preferably one of the embodiments described in FIGS. 11b-11d. Given the significant time (e.g., several nanoseconds) that it takes for the beam to traverse the spectral filter 150, it is preferred to adjust the arrival time of the filtered pulse to a second maximum of the discharge current. To achieve this temporal adjustment, an optical delay line is preferably inserted after the spectral filter 150. The delay line may be one of those described at U.S. patent application No. 60/130,392, which is assigned to the same assignee and is hereby incorporated by reference.

FIGS. 12b(i)-(iii) illustrate the electrical current through the discharge gap, the intensity of the un-narrowed beam 176 and the output 159 of the oscillator-amplifier system, each as a function of time. The current exhibits several cycles of oscillations, as shown in FIG. 12b(i). The optical pulse shown at FIG. 12b(ii) evolves towards the end of the first maximum (a) of current. The second maximum of electrical current is separated from the first one by approximately 20 nanoseconds, thus providing sufficient time for the beam 176 to traverse the spectral filter 150 and additional optical delay line 178. This discussion with respect to the timing of the successive maxima in the electrical discharge current reveals how the additional optical delay line 178 may be advantageously used to precisely tune the arrival time of the pulse at the chamber 170 (amplifier). The line-narrowed beam from the spectral filter 150, whose temporal pulse shape is shown at FIG. 12b(iii), thus overlaps the second maximum b of the electrical current shown at FIG. 12b(i) of the amplifier and is amplified, and thus a line-narrowed beam 159, i.e., substantially less than 1 pm, is output with sufficient.

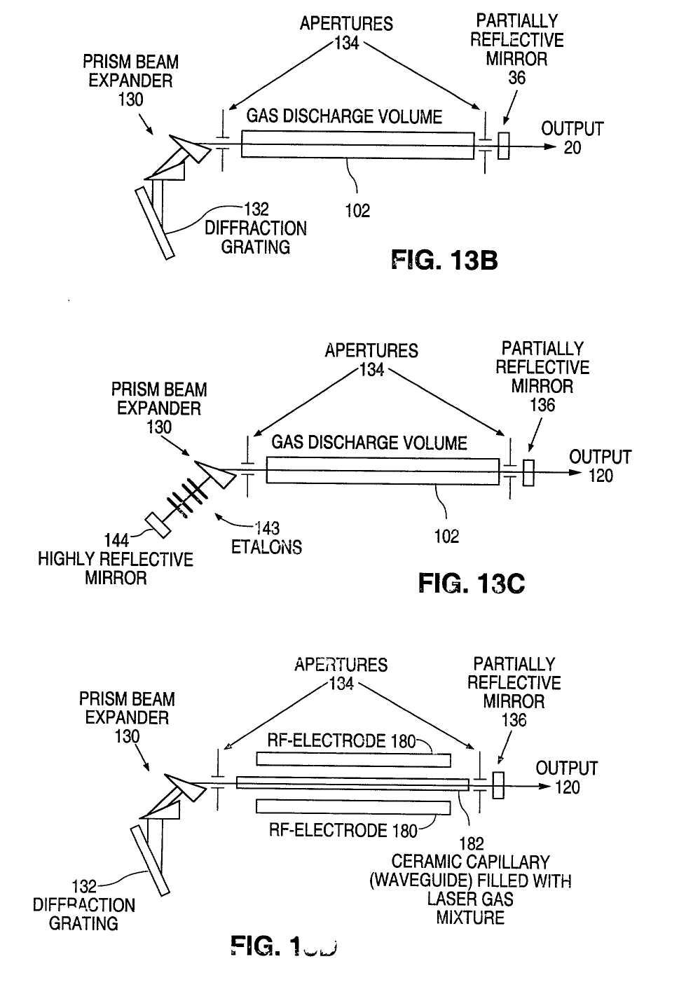

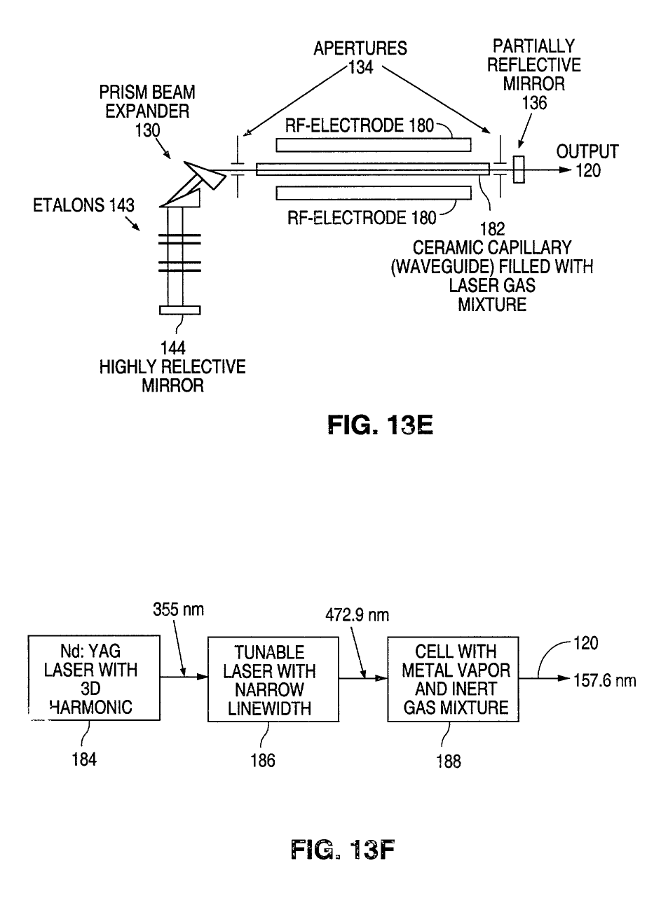

FIG. 13a shows the use of a line-narrowed oscillator followed by a power amplifier made in a separate discharge chamber. Any of the embodiments shown and described above including those discussed with respect to the exemplary embodiments, the patents and publications incorporated by reference, and the embodiments described with respect to FIGS. 10a-10f can be used to narrow the bandwidth of the oscillator. Examples of the preferred line-narrowed oscillator 148 are set forth at FIGS. 13b-13f.

The line-narrowed oscillator 148 schematically shown at FIG. 13(b) uses a prism beam expander 130 and grating 132, preferably as described in one or the U.S. Pat. No. 5,559,816, 298 22 090.3 DE, U.S. Pat. Nos. 4,985,898: 5,150,370, and 5,852,627 patents, each being incorporated by reference above. Alternatively, the Littman configuration may be used (see discussion above with respect to FIG. 10b). As discussed above with respect to the embodiments of FIGS. 10a-12a, the additional apertures 134 in the resonator reduce divergence of the beam and, therefore, advantageously increase the resolution of the wavelength selector (again, see the Ser. No. 09/130,277 application for details).

The embodiment shown in FIG. 13c utilizes multiple etalons 143 as wavelength selective elements (see FIG. 10d). The prism beam expander 130 in combination with the apertures 134 helps to reduce the divergence of the beam in the etalons 143 thus improving resolution of the wavelength selector. Additionally, this reduces the intensity of the beam at a particular area of the surfaces of the etalons 143, thus extending their lifetime.

FIGS. 13d-13e show alternative arrangements that each include an RF or microwave excited waveguide laser as an oscillator. The arrangement of FIG. 13d preferably includes a pair of RF-electrodes 180 and a waveguide 182 preferably including a ceramic capillary filled with a laser active gas mixture. Any of the resonator configurations shown in FIGS. 10a-13c may be used in this embodiment, wherein the discharge chamber 102 is replaced with the RF-excited waveguide arrangement shown in FIG. 13d. Features of the waveguide laser that may be used in the arrangement of FIGS. 13d-13e may be found at C. P. Christenson, Compact Self-Contained ArF Laser, Performing Organization Report Number AFOSR IR 95-0370; T. Ishihara and S. C. Lin, Theoretical Modeling of Microwave-Pumped High-Pressure Gas Lasers, Appl. Phys. B 48, 315-326 (1989); and Ohmi, Tadahiro and Tanaka, Nobuyoshi, Excimer Laser Oscillation Apparatus and Method, Excimer Laser Exposure Apparatus, and Laser Tube, European Patent Application EP 0 820 132 A2, each of which is hereby incorporated by reference. RF-excited lasers are commonly operated with a carbon dioxide gas medium, e.g., as discussed in Kurt Bondelie “Sealed carbon dioxide lasers achieve new power levels”, Laser Focus World, August 1996, pages 95-100, which is hereby incorporated by reference.

The specific arrangement shown in FIG. 13d includes a prism beam expander 130 and a grating 132 in Littrow configuration. A Littman configuration may be used here (see FIGS. 10b and 10f) including the grating 138 and HR mirror 140. A pair of apertures 134 are again included, particularly for matching the divergence of the resonator. A partially reflecting mirror 136 outcouples the beam 120. An etalon outcoupler 146 may be used instead of the mirror 136 (see FIGS. 10e-10f)

The arrangement schematically shown at FIG. 13e is the same as that of FIG. 13d, except that the grating is replaced with a one or more etalons 143 and an HR mirror 44. A grating 132 or 138 may be used along with the etalons 143, and an etalon outcoupler 146 may be used instead of the partially reflecting mirror 136.

An advantage of this RF-excited waveguide type of laser is its long pulse, which allows more efficient line narrowing, since the linewidth is approximately inversely proportional to the number of round trips of the beam in the resonator. Additionally, the RF-excited waveguide laser has a small discharge width (on the order of 0.5 mm) which allows high angular resolution of the wavelength selector based on the prisms of the beam expander 130 and the diffraction grating 132. This holds for both of the embodiments shown at FIGS. 13d-13e.

FIG. 13f schematically shows another source of a narrow linewidth beam that may be used in accordance with the present invention to serve as the oscillator 148 in the embodiment of FIG. 13a. The arrangement of FIG. 13f includes a solid state laser 185 with a third harmonic output at 355 nm, such as diode pumped, Nd:YAG laser or other such type laser as may be described, e.g., at U.S. Pat. No. 6,002,697, which is assigned to the same assignee and is hereby incorporated by reference, or as may be otherwise known to one skilled in the art. The solid state laser 185, in turn, pumps a narrow linewidth tunable laser 186, such as a dye laser or optical parametric oscillator, emitting, e.g., around 472.9 nm. This 472.9 nm radiation is focussed into a gas cell 188 containing a mixture of halide metal and inert gas, in order to produce a third harmonic beam at 157.6 nm. Such third harmonic generation in gases has been described at: Kung A. H., Young J. F., Bjorklung G. C., Harris S. E., Physical Review Letters, v.29, Page 985 (1972); and Kung A. H., Young J. F., Harris S. E, Applied Physics Letters, v.22 page 301 (1973), each of which is hereby incorporated by reference.

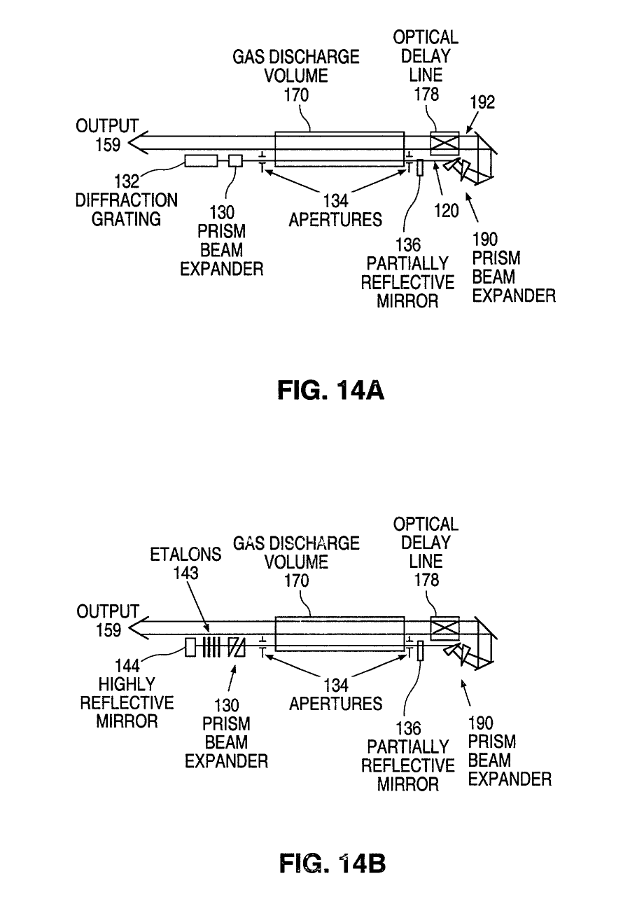

FIGS. 14a and 14b schematically illustrate further embodiments wherein a portion of the discharge volume of a discharge chamber 102 is used as an oscillator with line narrowing, and the same discharge chamber 102 is used as an amplifier 152. The arrangement of FIG. 14a is similar to that shown at FIG. 12a except that the linewidth of the beam 130 is narrowed within the resonator of the oscillator, and no spectral filter 150 is preferably used. A spectral filter 150 may alternatively be used in addition to the line-narrowing optics of the oscillator of FIG. 14a. Again, the line-narrowing arrangement of the oscillator may be modified as set forth in any of the descriptions above (see particularly FIGS. 10a-10f, 13c and 13f), or as set forth in any of the patents, patent applications or publications incorporated by reference in this application, or as otherwise understood by one skilled in the art, to produce a narrow output beam 120 sufficient to meet the first object of the invention. The output beam 120 from the oscillator is expanded by an external beam expander 190, preferably comprising one or more prisms and alternatively comprising a lens arrangement.

The expanded beam 192 is then directed through a delay line 178 (see the '392 application) to synchronize the pulse with the amplification maxima of the chamber 170, as described above. The optical delay line 178 serves to fine tune the arrival time of the optical pulse to the amplifier section, similar to the embodiment shown and described with respect to FIGS. 12a-12b(iii). The expanded beam 120 then advantageously fills a substantial portion of the rest of the discharge cross section, and is amplified.

In the above embodiments, it is preferred to adjust the gas mixture in the discharge chamber 102, 170 of the oscillator, to obtain the longest possible pulse. Additionally, the waveform of the discharge current can be modified by deliberately introducing an impedance mismatch of the pulse forming circuitry and discharge gap. The impedance mismatch leads to a longer discharge time and thus, to a longer optical pulse. The lower gain resulting from such modification means lower efficiency of the oscillator. However, in the embodiments discussed above, the amount of reduction in the output power of the oscillator is regained at the amplification stage.

Many other modifications may be made to the above preferred embodiments, which can also or alternatively be combined with each other, and which may be made to laser systems other than described above or that may be preferred herein. Some examples are provided below.

3310—A detector may be provided for measuring a parameter of the output beam including a light sensitive element and a frequency conversion coating particularly for absorbing incident 193 nm or 157 nm light, and may also be used for 248 nm light, and re-emitting light having a wavelength longer than 240 nm in a direction toward said light sensitive element, such that a dark current background, known to grow rapidly when light sensitive elements are used without protective frequency conversion coatings, is suppressed permitting the detector to have a lifetime of more than one billion laser pulses. The system may be operated manually, or may preferably further include a processor for receiving data from the detector and adjusting one or more components of the system in a feedback loop. The processor may receive data from the detector relating energy, wavelength, bandwidth, spectral purity, ASE, etc., and adjusts the parameter by communicating with the discharge unit, high voltage power supply and wavelength selection unit, etc. in a feedback loop.

3710/7920—An excimer laser system such as an argon fluoride or krypton fluoride laser system, may be provided including a laser gas with traces of an additive gaseous species, in addition to other features described elsewhere herein. A gas valve assembly may be coupled with the discharge chamber for controlling the gas mixture within the discharge chamber. The gas valve assembly may be coupled with gas supply lines including a first line for flowing the additive gas species, a second line for flowing a buffer gas of the laser gas, a third line for flowing a fluorine containing species of the laser gas, and a fourth line for flowing argon or krypton gas of the laser gas. The additive gaseous species preferably includes a molecular species different from each of the fluorine containing species, buffer gas and argon or krypton gas of the laser gas. The system may be modified for a molecular fluorine laser by not including the active rare gas. The presence of the additive gaseous species may be for controlling energy stability, output power or burst overshoot, and/or for wavelength calibration due to absorption by one or more lines of the additive species when the wavelength of the laser beam is tuned through such line or lines. The resonator would preferably include a tunable wavelength selection unit including, e.g, a beam expander and a grating for the excimer laser for providing a narrowed emission of said laser.

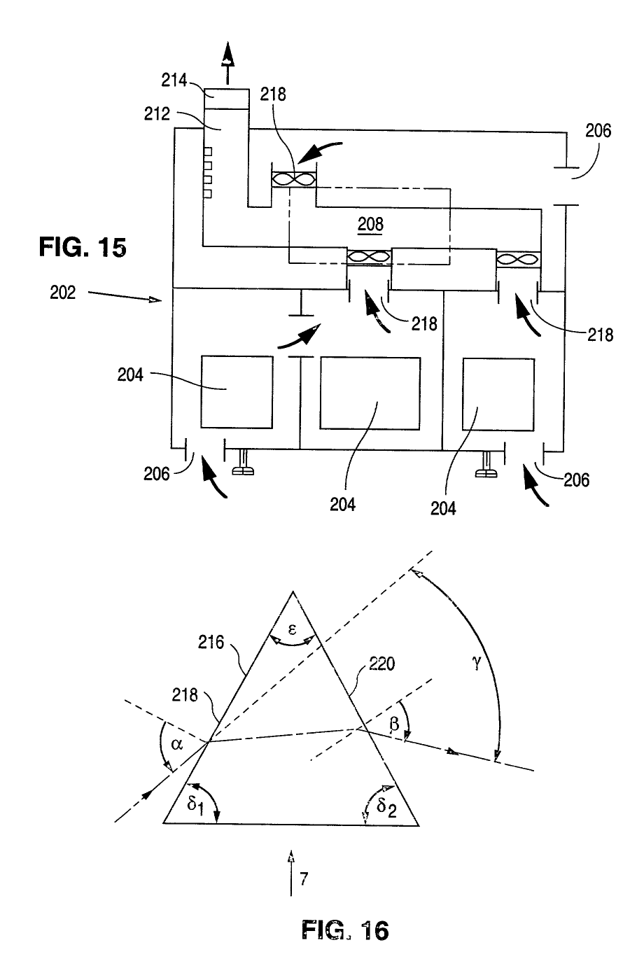

3910—A ventilation system, such as schematically shown at FIG. 15, for the laser may be provided including a housing 202 of the laser system which encloses multiple compartments 204 and includes at least one air inlet 206, an exhaust channel 208 defined within the housing for receiving exhaust from more than one of the multiple compartments 204, multiple intake ports 218 each of which is positioned downstream of at least one compartment 204 and upstream of the exhaust channel 208, a blower 212 for forcing exhaust to flow from multiple compartments 204 to the exhaust channel 208, and an exhaust port 214 for expelling exhaust from the exhaust channel 208.

7310—A line narrowing unit for the excimer or molecular fluorine laser resonator may include a dispersive prism 216, as schematically shown at FIG. 16, including a bulk material which is substantially transparent at an emission wavelength of the laser system such as 248 nm, 193 nm or 157 nm, wherein CaF₂ is suitable at each of these wavelengths. The prism 216 being arranged at a particular orientation within the resonator for dispersing the beam such that only a selected portion of the spectral bandwidth of the beam remains within an acceptance angle of said resonator and other unselected portions are dispersed outside of the acceptance angle of said resonator. The prism 216 may include an entrance surface 218 at which a laser beam is incident and refracted into the bulk material, and an exit surface 220 at which the beam exits and refracts out of the bulk material, wherein each surface may or may not have an AR coating thereon. The beam preferably makes a non-symmetric pass through the prism 216, such that an entrance angle α of the beam at the entrance surface 218 of the prism 216 differs from an exit angle β of the beam at the exit surface 220 of the prism 216. Preferably, and one of the entrance and exit angles α and β, respectively, is greater than Brewster's angle (e.g., around 56°) and the other is at least around Brewster's angle.

3110—A spectral parameter of the output beam of the laser system may be controlled, using one or more processors, an energy detector and/or a spectrometer and a wavelength selection unit, by providing an adjustable optical component, such as one having a curved surface and/or an aperture, within the resonator for providing the output beam with improved spectral purity. Beam energy and/or a spectral parameter may be measured with the energy detector and/or spectrometer, while the spectral parameter is preferably either spectral purity, bandwidth or wavelength. Signals may be sent to the one or more processors indicative of the beam energy and/or spectral parameter. The optical component may be adjusted within the resonator for controlling the spectral parameter of the beam based on the spectral parameter signals sent to at least one of the one or more processors.

2910/4740—For an F₂-laser system in particular, which generates a characteristic spectral band including multiple closely-spaced spectral lines in a wavelength range between 157 nm and 158 nm, wavelength selection optics may be provided for selecting one or more of the multiple closely-spaced lines as an output emission of said laser. This system may include an evacuatable optics block disposed in the resonator containing the wavelength selection optics for maintaining the wavelength selection optics in an atmosphere below a predetermined reduced pressure within the resonator sufficient to enable the spectral band to propagate within the optics block without substantial attenuation due to the presence of photoabsorbing species within the optics block. The optics block may alternatively be purged with flowing or stagnant inert gas, and beam paths between the discharge chamber and optics modules on one or both side of the resonator may have prepared beam paths within one or more enclosures, and an extracavity beam path may be purged or evacuated to protect the output beam. Similar enclosures may be advantageously used for an ArF laser emitting around 193 nm.

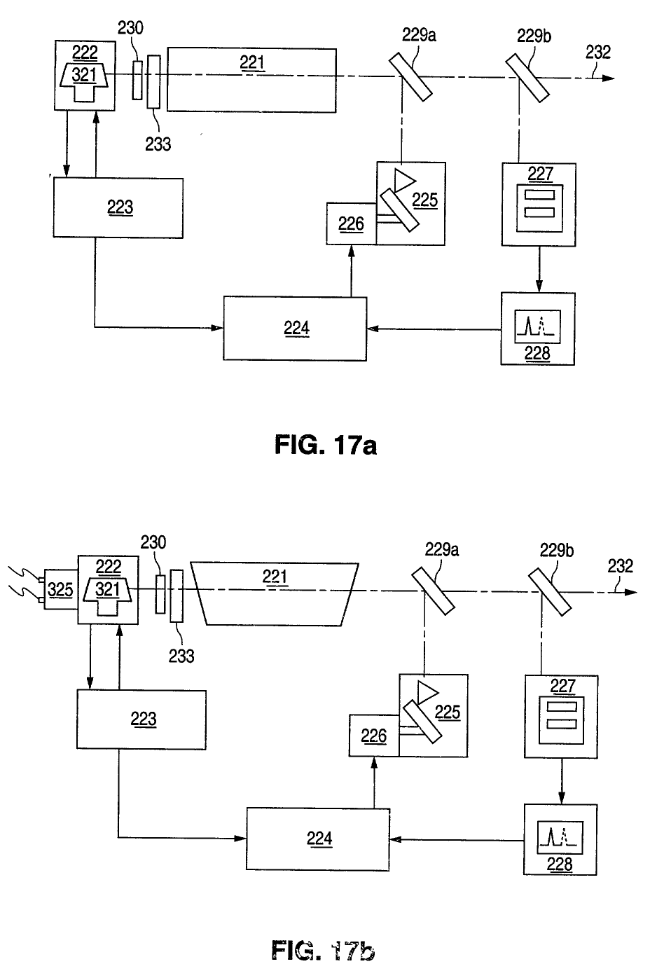

3240—A technique for determining the absolute wavelength of spectral emission of a narrow emission excimer or molecular fluorine laser system may include a wavelength calibration system including a module 321 within a housing 222, such as schematically illustrated at FIGS. 17a-17b, filled with a gas including a species having at least one optical inter-level transition within the emission spectrum of said excimer or molecular fluorine laser system. An exemplary system may include a laser chamber 221, line-narrowing unit 225, tuning controller 226, processor 224, controller 223, resonator reflector 230, optional plate 233, and beam splitters 229a, 229b for reflecting diagnostic beams and allowing the main beam 232 to continue to an industrial process. In the embodiment of FIG. 17a, the oipto-galvanic effect is used. In the embodiment of FIG. 17b, a detector 325 detects an intensity wherein minima indicate absorption at lines of the gas within the nodule 321. The output would be line-narrowed, and the line-narrowed output would be directed through the gas filling the module 321. The narrowed emission would be tuned within the larger characteristic emission spectrum, and at least one optical inter-level transition of the species would be detected when the narrowed emission is tuned, and the absolute wavelength of the narrowed emission may be thereby determined. For the F₂ laser, selenium, silicon, bromine and/or platinum may be used as the gas species. For the ArF laser, preferably iron and/or platinum is used. For the KrF laser, preferably iron is used.

3540—A technique for controlling a status of a laser gas mixture of the excimer or molecular fluorine gas discharge laser system may include determining a slope of a output beam energy versus input voltge to the discharge electrodes of the laser system. A status of the laser gas mixture may be determined and corrected based on the slope. Micro-halogen injections, e.g., may be performed to correct the gas mixture.

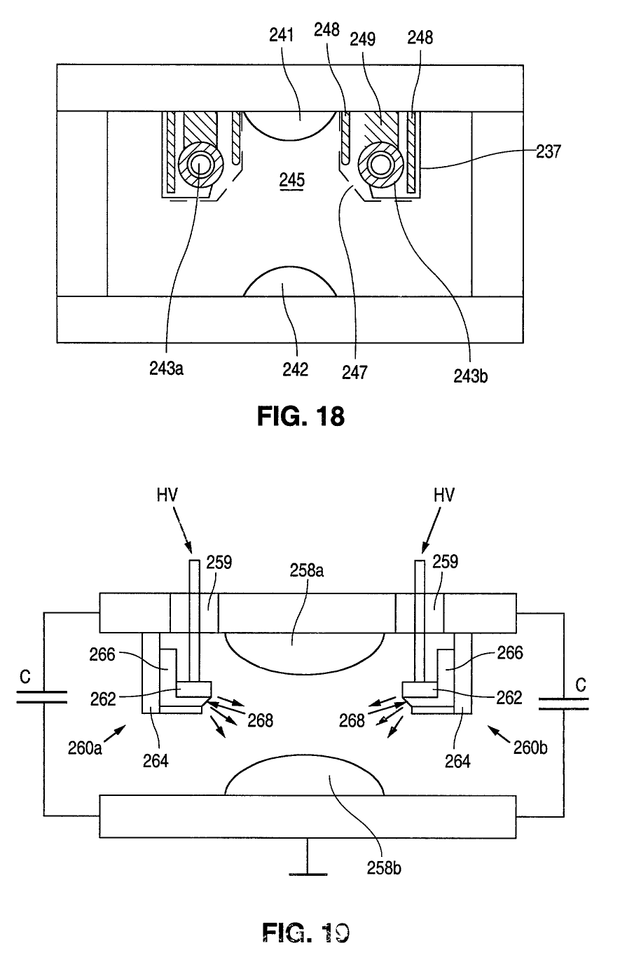

3600/5610—A corona-type preionization unit for the laser, wherein a discharge chamber of the laser is schematically illustrated in cross section at FIG. 18, may include an elongated internal preionization electrode 243a within an elongated dielectric tube 243b, and an external preionization electrode 237 having a cross-sectional shape formed to shield the tube 243b from areas within the discharge chamber outside of the main discharge area 245 between the first and second main discharge electrodes 241, 242. The external preionization electrode 237 may include an ultraviolet semi-transparent portion 247 configured to partially shield the preionization unit from the main discharge area 245. Insulators 248 and 249 may facilitate the placement of the smei-transparent shield 247 around the tube 243b. As illustrated at FIG. 19, a sliding surface-type preionization unit 260a, 260b may be provided instead of the above-described corona-type. As schematically illustrated at FIG. 19, as discharge chamber cross-section may include a pair of main electrodes 258a, 258b, an insulating feedthrough portion 259 for each high voltage preionization electrode 262 to feed into the chamber, an insulator 266 is provided between the HV electrode 262 and a counter electrode 264

3800—The excimer or molecular fluorine laser may include at least a beam expander and a dispersion element for line-narrowing and/or line-selection. The beam expander preferably is separate from the dispersion element. The beam expander, according to this embodiment, has an adjustable magnification, e.g., being synchronously rotatable, within the resonator for adjustably magnifying the angular dispersion of the dispersion element such that the linewidth of the beam may be adjusted to a selected value.

4220—An F₂-laser may include an interferometric device such as a reflective or transmissive etalon or a different device having non-plane parallel plates for generating a laser beam having a bandwidth of around 1 pm or less. The interferometric device may be configured for having a response maximum around a primary line of multiple characteristic lines of the laser for maximum transmissivity of the primary line and having a response minimum around the secondary line for relatively low transmissivity of the secondary line to substantially suppress the secondary line, thereby selecting the primary line such that the F₂-laser emits a single wavelength laser beam having a narrow spectral linewidth that is less than the bandwidth of a free-running F₂-laser to provide a narrow band VUV laser beam.

4610—The laser system may include a gas supply unit and a processor configured to permit a quantity of fluorine gas less than between 3% and 7% of an amount of the fluorine gas currently in the discharge chamber to inject into the discharge chamber at selected intervals. These micro-halogen injections are preferred over injections of larger amounts of halogen so as not to substantially disturb other laser system parameters as a result of the injection.

5120—The excimer or molecular fluorine laser system may include a deformable, non-dispersive reflector within its resonator adjustably improving a laser system parameter such as bandwidth or spectral purity. A processor preferably receives a signal indicative of the laser system parameter from a detector and controls a surface contour of the deformable reflector in a feedback loop.

5220/6110—The excimer or molecular fluorine laser may be programmed with a gas control circuit wherein a parameter is measured, and a gas mixture status determined and/or adjusted based on the value of the measured parameter. Examples of parameters that may be measured in this regard include amplified spontaneous emission (ASE) and breakdown gas mixture voltage. For the former example, preferably a filter separates stimulated emission from spontaneous emission prior to measuring the ASE, which allows the ASE signal to be measured without being overwhelmed by stimulated emission within the beam portion to be measured. In the latter case, special probe electrodes may be used for measuring the breakdown voltage either directly or by measuring a discharge frequency of the continuously charging electrodes.

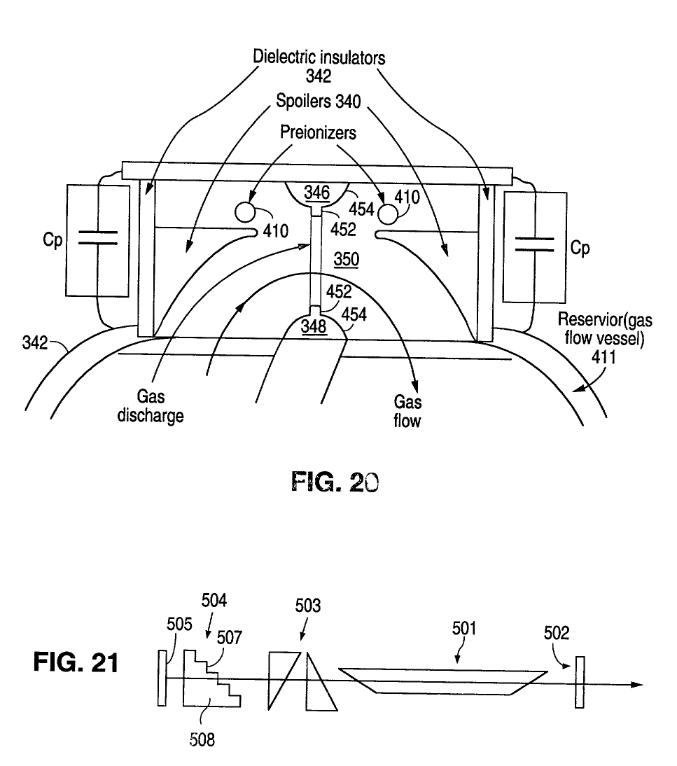

5810—The discharge chamber of the excimer or molecular fluorine laser schematically shown at FIG. 20 in cross section includes a spoiler 340 formed together with the chamber 342 as a single dielectric assembly. The spoiler 340 is preferably spaced from each main electrode 346, 348 and shaped, e.g., preferably rounded to conform with the flow of the gas mixture, to provide an uniform gas flow through the discharge area 350. One or both of the electrodes 346 and 348 may include a base 454 and a nipple 452 for providing a reduced narrow discharge area 350. The preionization electrodes 410 are also advantageously shielded from arcing with the electrode 348 while not being blocked from exposing the gas in the discharge area 350 with UV light. Peaking capacitors Cp and a top portion of the gas flow vessel 411 including a heat exchanger and blower (not shown) are shown for perspective.

6410—The laser system resonator schematically shown at FIG. 21 includes a grism 504, or integrated prism-grating optic, for line-selection and or line-narrowing. The resonator shown further includes a discharge chamber 501, output coupler 502, beam expander 503 and HR mirror 505. The grism includes a grating surface 507 and prismatic bulk portion 508. The grism may be an output coupler with partial reflection from one surface, or may be intracavity (as shown) without substantial reflection from either surface.

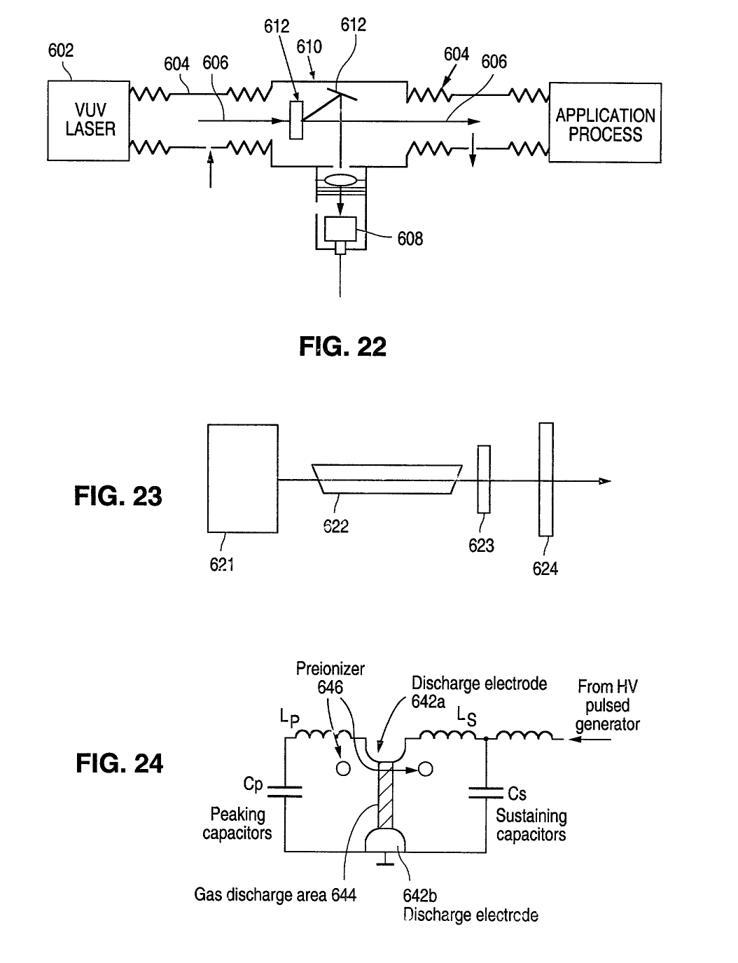

6610—As illustrated at FIG. 22, a VUV laser system, such as an F₂ or ArF laser system may include a VUV laser 602, a sealed enclosure 604 connected to the resonator providing an output beam path for the beam 606 as it exits the resonator that is substantially free of VUV photoabsorbing species so that the energy of the beam can reach an application process without substantial attenuation due to the presence of photoabsorbing species along said output beam path. A detector 608 is also optically coupled with the enclosure 604 for detecting a parameter of the output beam 606, and a beam splitter module 610 is within the enclosure and/or coupled thereto for directing part of the beam to the detector 608. The part of said beam that is directed to the detector is directed along a beam path within the enclosure 604/module 610 that is protected from being substantially attenuated by VUV photoabsorbing species, such that in operation of the VUV laser system, the detector 608 detects the parameter of the output beam 606 by detecting the part of said beam that is directed to the detector 608 from the beam splitter module 610 along the beam path within the enclosure and not substantially attenuated by the VUV photoabsorbing species. Optics 612 serve to redirect the beam portion to be detected, and preferably also for the F₂ laser, an optic for filtering red light from the beam portion such as a holographic beam sampler, dichroic optics, etc.

6710—An apparatus for reducing speckle of a laser beam may, according to the schematic illustration of FIG. 23 also showing a discharge tube 622, line-narrowing module 621 with HR surface (not shown) and output coupler 623, include a DUV-VUV transparent substrate 624 configured to alter at least a first portion of the beam transmitted through at least a first region of the substrate 624 relative to light transmitted outside of the first region of the substrate, such that the substrate 624 generates a desired minimum number of spatially coherent cells in the laser beam. Another apparatus for reducing speckle of a laser beam may alternatively include a DUV-VUV reflecting substrate 624 configured to alter at least a first portion of the beam reflected from a first region of the substrate 624 relative to light reflected from outside of the first region of the substrate 624, such that the substrate generates a desired minimum number of spatially coherent cells in the laser beam.

7410—A pulse compression circuit for the pulsed discharge unit of the excimer or molecular fluorine laser system may include one or more pulse compression stages each including a stage capacitance and being separated by a stage inductance. Referring to the schematic of FIG. 24, a final stage capacitance is preferably provided by a set of peaking capacitors Cp connected to the main electrodes 642a, 642b through a first inductance Lp, and a set of sustaining capacitors Cs connected to the electrodes 642a, 642b through a second inductance Ls substantially greater than the first inductance Lp. Current pulses through the discharge are temporally extended relative to current pulses of a circuit having its final stage capacitance provided only by a set of peaking capacitors connected to electrodes via a lower inductance than the second inductance Ls such as said first inductance Lp. A background amplified spontaneous emission (ASE) level in the pulses is reduced thereby enhancing spectral purity of the output beam. The preionization electrodes 646 and discharge region 644 are also illustrated.

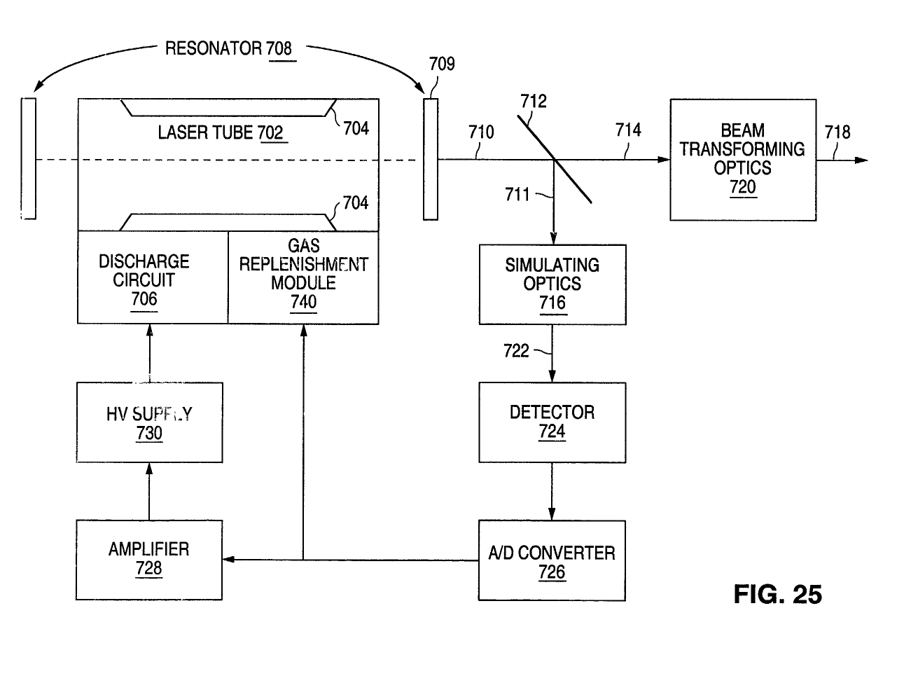

8310—The laser system may include the components ischematically illustrated at FIG. 25 which shows a laser tube 702 including main electrodes 704 connected to discharge circuit 706 energized by HV supply 730 and within a resonator 708 including an output coupler 709. The output beam 710 reflects from a beam splitter 712 and a reflected beam portion 711 traverses simulation optics 716 which transform the beam. The transformed beam 722 impinges upon detector 724. The main beam 714 traverses beam transforming optics 720 such as an imaging system of a photolithography system which also change the beam 718 that will be incident at a workpiece. The simulation optics 716 are designed to transform the beam as the beam transforming optics 720 do, so that the detected beam 722 is similarly transformed. An A/D converter 726 and amplifier 728 are also shown. Beam splitting means 712 for creating a primary output beam 714 and a diagnostic beam 711 from the output beam 710 are illustrated at FIG. 25. Beam transforming means 720 may be provided for inducing a first beam parameter transformation in the primary output beam 714. Beam simulation means 716 may be further provided for inducing a second beam parameter transformation in the diagnostic beam 711. A detector 724 measures a beam parameter of the diagnostic beam 722 after the second beam parameter transformation is induced. The first beam parameter transformation induced in the primary output beam 714 is substantially the same as the second beam parameter transformation induced in the diagnostic beam 711.

While exemplary drawings and specific embodiments of the present invention have been described and illustrated, it is to be understood that that the scope of the present invention is not to be limited to the particular embodiments discussed. Thus, the embodiments shall be regarded as illustrative rather than restrictive, and it should be understood that variations may be made in those embodiments by workers skilled in the arts without departing from the scope of the present invention as set forth in the claims that follow, and equivalents thereof.

In addition, in the method claims that follow, the steps have been ordered in selected typographical sequences. However, the sequences have been selected and so ordered for typographical convenience and are not intended to imply any particular order for performing the steps, except for those claims wherein a particular ordering of steps is expressly set forth or understood by one of ordinary skill in the art as being necessary.

What is claimed is:

1. A method of forming a diffraction grating in the surface of a substrate, said method comprising the steps:
generating an ion beam;
patterning said ion beam;
impinging said patterned beam onto said surface to thereby form said grating therein.

2. A method of claim 1, wherein said patterning comprises passing said beam through an attenuator having a structure according to the structure of said grating.

3. A method of claim 2, wherein said attenuator is substantially made of epoxy.

4. A method of forming a diffraction grating in the surface of a substrate, said method comprising the steps:
providing an ion beam;
attenuating said ion beam according to the structure of said diffraction grating;
irradiating said surface with said attenuated beam;
wherein said attenuated ion beam forms said grating in said surface.

5. An excimer or molecular fluorine laser, comprising:
an oscillator for generating a pulsed sub-0.6 nm, sub-250 nm laser beam, including:
a laser tube including a discharge chamber filled with a laser gas mixture at least including molecular fluorine and a buffer gas;
a plurality of electrodes in the discharge chamber connected to a pulsed discharge circuit for energizing the gas mixture;
a resonator surrounding the gas mixture for generating a pulsed sub-250 nm laser beam; and
a line-narrowing unit for narrowing the bandwidth of said laser, said line-narrowing unit including a grating and narrowing said bandwidth to less than 0.6 pm, and
an amplifier for increasing an energy of the pulsed sub-0.6 pm, sub-250 nm laser beam, including
a laser tube including a discharge chamber filled with a laser gas mixture at least including molecular fluorine and a buffer gas;
a plurality of electrodes in the discharge chamber connected to a pulsed discharge circuit for energizing the gas mixture at times when pulses of the sub-250 nm laser beam generated by the oscillator are present within the discharge chamber; and
a resonator surrounding the gas mixture for generating a laser beam.

6. The laser of claim 5, wherein said bandwidth is less than 0.5 pm.

7. The laser of claim 5, wherein said bandwidth is less than 0.4 pm.

8. The laser of claim 5, wherein said grating has a blaze angle of at least 78°.

9. The laser of claim 5, wherein said grating has a blaze angle between 78° and 82°.

10. The laser of claim 5, wherein said grating has a blaze angle greater than 80°.

11. The laser of claim 5, wherein said grating has a coating comprising a reflective dielectric material.

12. The grating of claim 5, wherein said grating has at least 10,000 grooves per centimeter.
